(19) United States
(12) Patent Application Publication
(10) Pub. No.: US 2019/0182476 A1
(43) Pub. Date: Jun. 13, 2019

(54) STEREOSCOPIC DISPLAY DEVICE

(71) Applicant: SHARP KABUSHIKI KAISHA, Sakai City (JP)

(72) Inventors: RYOH KIKUCHI, Sakai City (JP); TAKEHIRO MURAO, Sakai City (JP); TAKAYUKI YAMADA, Sakai City (JP)

(21) Appl. No.: 16/213,878

(22) Filed: Dec. 7, 2018

(30) Foreign Application Priority Data
Dec. 13, 2017 (JP) 2017-238653

(51) Int. Cl. H04N 13/31; H04N 13/398; H04N 13/366; G02F 1/1343; H04N 13/359; G02B 27/22

(52) U.S. Cl. CPC H04N 13/31; H04N 13/398; G02B 27/2214; G02F 1/134309; H04N 13/359; H04N 13/366

(57) ABSTRACT

First electrodes and second electrodes of a switching liquid crystal panel of a stereoscopic display device are provided on different layers with an insulating film interposed, gaps between the second electrodes are light-transmitting regions, the first electrodes are provided corresponding to gaps between the second electrodes in plan view, and, when an electrode width of the first electrodes, a gap width of the first electrodes, an electrode width of the second electrodes, and a gap width of the second electrodes in the X-axis direction are taken as WL1, GL1, WU1, and GU1 respectively, WU1=GL1<WL1=GU1.

### BACKGROUND

### 1. Field

The present disclosure relates to a stereoscopic display device.

### 2. Description of the Related Art

There are tracking methods that are known as techniques for improving the narrowness of a viewing range during 3D in stereoscopic display devices with which a 3D display can be viewed with the naked eye, such as an eye tracking method in which the positions of the eyes are recognized by a camera and left and right images that match the positions of the eyes are appropriately output, for example.

Furthermore, a barrier division SW-LCD method is known as a method in which it is possible to switch between a 2D (two-dimensional) display and a 3D display, it is possible to display at full resolution during a 2D display, and the viewing angle for 3D can be enlarged by means of tracking.

In the barrier division SW-LCD method, a switching liquid crystal panel is used, which is formed in cells by arranging electrodes on each of a first substrate and a second substrate and adhering these together, a voltage is applied to the electrodes, and light-shielding portions (barriers) are thereby generated.

As a stereoscopic display device using this kind of method, the applicant and so forth of the present application proposed a stereoscopic display device in which a display panel, a switching liquid crystal panel, a control unit, and a position sensor are provided, a plurality of first electrodes are arranged on a first substrate and a plurality of second electrodes are arranged on a second substrate of the switching liquid crystal panel, and the first electrodes and the second electrodes are arranged mutually offset in the alignment direction of these first electrodes and second electrodes (see the International Publication No. 2014/136610 pamphlet (published internationally on Sep. 12, 2014)).

According to the International Publication No. 2014/136610 pamphlet, the control unit controls the potential of the first electrodes and the potential of the second electrodes in accordance with position information regarding an observer, and thereby changes a barrier pattern in accordance with the position of the observer.

However, in the aforementioned stereoscopic display device, barrier widths change depending on the barrier pattern, and therefore, when the face of the observer moves, a difference occurs in 3D characteristics (crosstalk and luminance changes). As a result, in the aforementioned stereoscopic display device, display quality changes depending on the observation position, and the observer experiences a sense of discomfort from, for example, crosstalk (double projection) or luminance flickering caused by the barrier pattern changing depending on the observation position.

Thus, an aspect of the present disclosure aims to realize a stereoscopic display device with which a satisfactory display quality can be obtained even if the observation position changes.

### SUMMARY

To address the aforementioned issue, a stereoscopic display device according to one aspect of the present disclosure is provided with: a display panel that displays an image; and a switching liquid crystal panel that is arranged superposing the display panel, in which the switching liquid crystal panel is provided with a first substrate and a second substrate arranged in an opposing manner with a liquid crystal layer interposed, the first substrate has a plurality of first electrodes arranged in one direction of the first substrate, the second substrate has at least one second electrode, the plurality of first electrodes have a plurality of first lower electrodes arranged spaced apart from each other in the one direction, and a plurality of first upper electrodes arranged spaced apart from each other in the one direction, the first lower electrodes and the first upper electrodes are provided in different layers with a first insulating film interposed, so as to be positioned in an alternating manner in the one direction in plan view, gaps between the first upper electrodes that are adjacent are light-transmitting regions, the first lower electrodes are provided respectively corresponding to the gaps between the first upper electrodes in plan view, and, when an electrode width of the first lower electrodes in the one direction is taken as WL1, a gap width of gaps between the first lower electrodes in the one direction is taken as GL1, an electrode width of the first upper electrodes in the one direction is taken as WU1, and a gap width of the gaps between the first upper electrodes in the one direction is taken as GU1, WU1=GL1<WL1=GU1.

### BRIEF DESCRIPTION OF THE DRAWINGS

FIG. 1 is a cross-sectional view depicting an enlargement of a portion of a switching liquid crystal panel in a stereoscopic display device according to embodiment 1 of the present disclosure;

FIG. 2 is a cross-sectional view depicting an example of a configuration of a main portion of the stereoscopic display device according to embodiment 1 of the present disclosure;

FIG. 3 is block diagram depicting a schematic configuration of the stereoscopic display device according to embodiment 1 of the present disclosure;

FIG. 4A is a cross-sectional view depicting a schematic configuration of a main portion of the stereoscopic display device according to embodiment 1 of the present disclosure, and FIG. 4B is a cross-sectional view depicting a schematic configuration of a main portion of a main liquid crystal panel according to embodiment 1 of the present disclosure;

FIG. 5 is flowchart depicting a processing flow of the stereoscopic display device according to embodiment 1 of the present disclosure;

FIG. 6 is a cross-sectional view depicting a schematic configuration of a main portion of the switching liquid crystal panel according to embodiment 1 of the present disclosure;

FIG. 7 is an explanatory diagram depicting a rubbing direction of each alignment film of the switching liquid crystal panel according to embodiment 1 of the present disclosure;

FIG. 8 is an explanatory diagram depicting a relationship between an absorption axis of a polarizer of the switching liquid crystal panel according to embodiment 1 of the present disclosure, and an absorption axis of a polarizer at a switching liquid crystal panel side in the main liquid crystal panel;

FIG. 9A is a plan view schematically depicting a configuration of a main portion of a second substrate of the switching liquid crystal panel according to embodiment 1 of the present disclosure, and FIG. 9B is a plan view schematically depicting a configuration of a main portion of a first substrate of the switching liquid crystal panel according to embodiment 1 of the present disclosure;

FIG. 10 is a cross-sectional view depicting an enlarged portion of a switching liquid crystal panel in a stereoscopic display device used in comparative example 1;

FIG. 11 is an explanatory diagram schematically depicting a relationship between an observation position and a barrier pattern of the switching liquid crystal panel in the stereoscopic display device according to comparative example 1;

FIG. 12 is a graph depicting angle characteristics for crosstalk in a case where the observation position has been changed as depicted in FIG. 11, in the stereoscopic display device according to comparative example 1;

FIG. 13 is a graph depicting luminance characteristics in a case where the observation position has been changed as depicted in FIG. 11, in the stereoscopic display device according to comparative example 1;

FIG. 14 is a cross-sectional view schematically depicting a relationship between electrode widths and barrier widths in the X-axis direction of barrier electrodes that light up in comparative example 1;

FIG. 15A is an explanatory diagram depicting barrier widths in the X-axis direction in barrier patterns when an even number of barrier electrodes are lit up in comparative example 1, and FIG. 15B is an explanatory diagram depicting barrier widths in the X-axis direction in barrier patterns when an odd number of barrier electrodes are lit up in comparative example 1.

FIG. 16 is an explanatory diagram schematically depicting a relationship between observation positions and barrier patterns of the switching liquid crystal panel in the stereoscopic display device according to comparative example 1;

FIG. 17 is a cross-sectional view schematically depicting a relationship between electrode widths and barrier widths in the X-axis direction of barrier electrodes that light up in example 1;

FIG. 18 is an explanatory diagram schematically depicting a relationship between observation positions and barrier patterns of a switching liquid crystal panel in a stereoscopic display device according to example 1;

FIG. 19 is a graph depicting angle characteristics for crosstalk in a case where the observation position has been changed as depicted in FIG. 18, in the stereoscopic display device according to example 1;

FIG. 20 is a graph depicting luminance characteristics in a case where the observation position has been changed as depicted in FIG. 18, in the stereoscopic display device according to example 1;

FIG. 21 is a drawing depicting actual measurement results for barrier widths in the X-axis direction, using an electron micrograph, in a case where only barrier electrodes in an upper electrode layer have been lit up, and in a case where only barrier electrodes in a lower electrode layer have been lit up, in example 1 and comparative example 1;

FIG. 22 is a drawing depicting actual measurement results for barrier widths in the X-axis direction, using an electron micrograph, in observation positions in a case where seven barrier electrodes have been lit up and in a case where five barrier electrodes have been lit up in example 1 and comparative example 1;

FIG. 23 is a graph depicting actual measurement results for crosstalk in observation positions when an odd number of barrier electrodes have been lit up in the stereoscopic display device according to example 1;

FIG. 24 is a graph depicting actual measurement results for crosstalk in observation positions when an odd number of barrier electrodes have been lit up in the stereoscopic display device according to comparative example 1;

FIG. 25 is a graph depicting actual measurement results for luminance distributions in observation positions when an odd number of barrier electrodes have been lit up in the stereoscopic display device according to example 1;

FIG. 26 is a graph depicting actual measurement results for luminance distributions in observation positions when an odd number of barrier electrodes have been lit up in the stereoscopic display device according to comparative example 1;

FIG. 27 is a plan view depicting a schematic configuration of a main portion of a main liquid crystal panel according to embodiment 2 of the present disclosure;

FIG. 28 is a cross-sectional view depicting a schematic configuration of a main portion of a switching liquid crystal panel according to embodiment 2 of the present disclosure;

FIG. 29A is a plan view schematically depicting a configuration of a main portion of a second substrate of the switching liquid crystal panel according to embodiment 2 of the present disclosure, and FIG. 29B is a plan view schematically depicting a configuration of a main portion of a first substrate of the switching liquid crystal panel according to embodiment 2 of the present disclosure;

FIG. 30 is a cross-sectional view depicting an enlargement of a portion of the switching liquid crystal panel in a stereoscopic display device according to embodiment 2 of the present disclosure;

FIG. 31 is a cross-sectional view depicting an example of a configuration of a main portion of the stereoscopic display device according to embodiment 2 of the present disclosure;

FIG. 32A is a graph depicting actual measurement results for crosstalk in observation positions when an odd number of only barrier electrodes of a first substrate have been lit up in the stereoscopic display device according to embodiment 2 of the present disclosure, and FIG. 32B is a graph depicting actual measurement results for crosstalk in observation positions when an odd number of only barrier electrodes of a second substrate have been lit up in the stereoscopic display device according to embodiment 2 of the present disclosure;

FIG. 33A is a graph depicting actual measurement results for luminance distributions in observation positions when an odd number of only barrier electrodes of the first substrate have been lit up in the stereoscopic display device according to embodiment 2 of the present disclosure, and FIG. 32B is a graph depicting actual measurement results for luminance distributions in observation positions when an odd number of only barrier electrodes of the second substrate have been lit up in the stereoscopic display device according to embodiment 2 of the present disclosure; and

FIG. 34 is a cross-sectional view depicting a schematic configuration of a main portion of a stereoscopic display device according to embodiment 3 of the present disclosure.

### DESCRIPTION OF THE EMBODIMENTS

Hereinafter, an embodiment of the present disclosure will be described in detail. Note that, in the description given hereinafter, wording such as “the same” or “equal” includes “substantially the same” or “substantially equal”.

### Embodiment 1

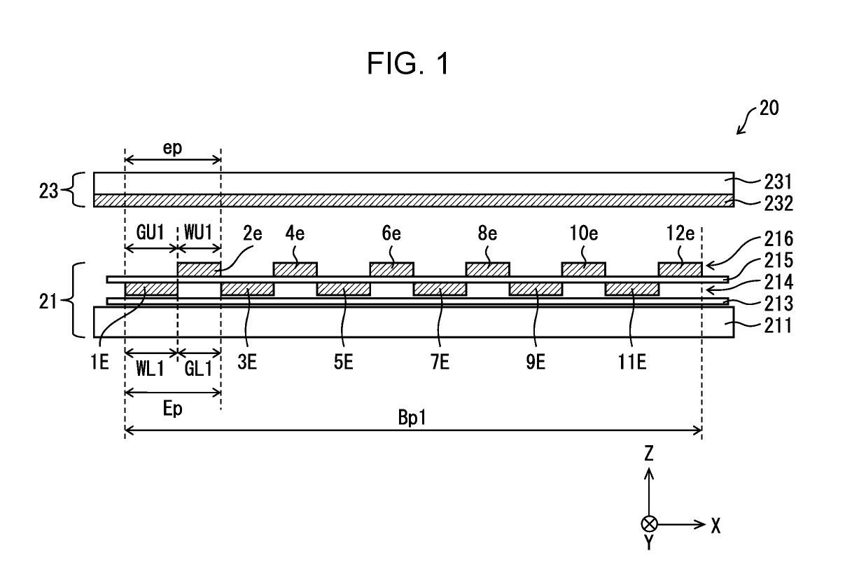

Hereinafter, an embodiment of the present disclosure is as follows when described based on FIGS. 1 to 26.

### <Schematic Configuration of Stereoscopic Display Device>

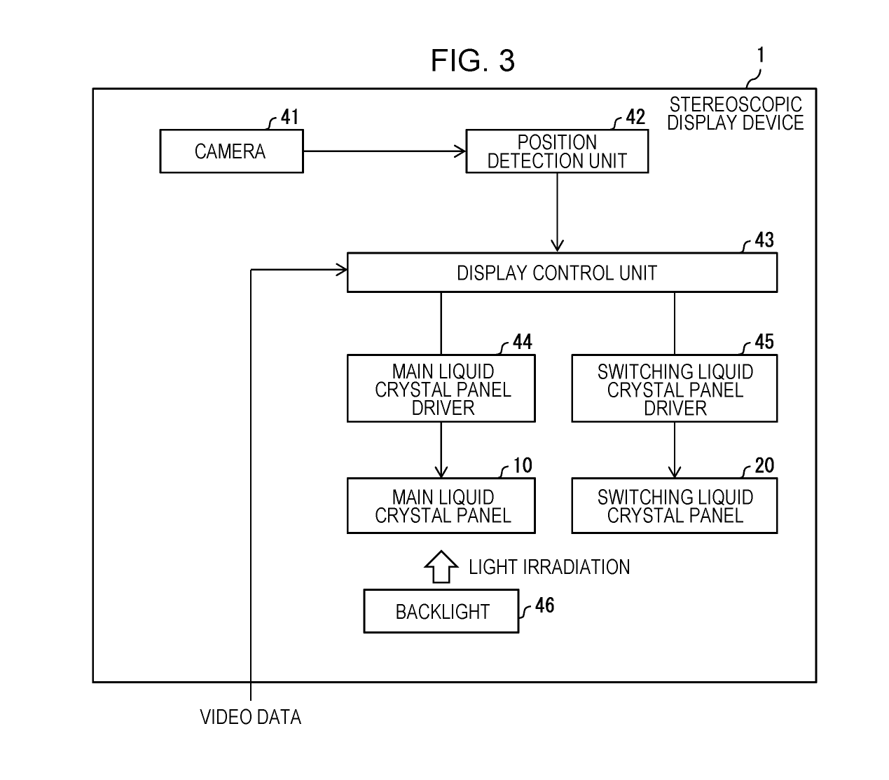

FIG. 3 is block diagram depicting a schematic configuration of a stereoscopic display device 1 according to the present embodiment. Note that, hereinafter, for the convenience of the description, the normal direction (vertical direction) of a substrate of the stereoscopic display device 1 is referred to as the Z-axis direction, and, from among the horizontal directions perpendicular to the Z-axis direction, the horizontal direction in the arrangement direction of segment electrodes is referred to as the X-axis direction (row direction), and the horizontal direction perpendicular to the X-axis direction is referred to as the Y-axis direction (column direction).

As depicted in FIG. 3, the stereoscopic display device 1 is provided with a main liquid crystal panel 10 (first liquid crystal panel), a switching liquid crystal panel 20 (second liquid crystal panel), a camera 41, a position detection unit 42, a display control unit 43, a main liquid crystal panel driver 44, a switching liquid crystal panel driver 45, and a backlight 46.

The main liquid crystal panel 10 is a display panel that displays images on the basis of video signals that are input from outside. The switching liquid crystal panel 20 is a liquid crystal panel for forming parallax barriers that separate an image for the left eye and an image for the right eye. The main liquid crystal panel driver 44 drives the main liquid crystal panel 10 on the basis of video data (video signals) that is input from outside. The switching liquid crystal panel driver 45 drives the switching liquid crystal panel 20 on the basis of video data (video signals) that is input from outside. The backlight 46 radiates light onto the main liquid crystal panel 10. The position detection unit 42 detects the facial position of an observer from a facial image of the observer acquired by the camera 41. The display control unit 43 controls the main liquid crystal panel driver 44 and the switching liquid crystal panel driver 45 on the basis of video data and output from the position detection unit 42.

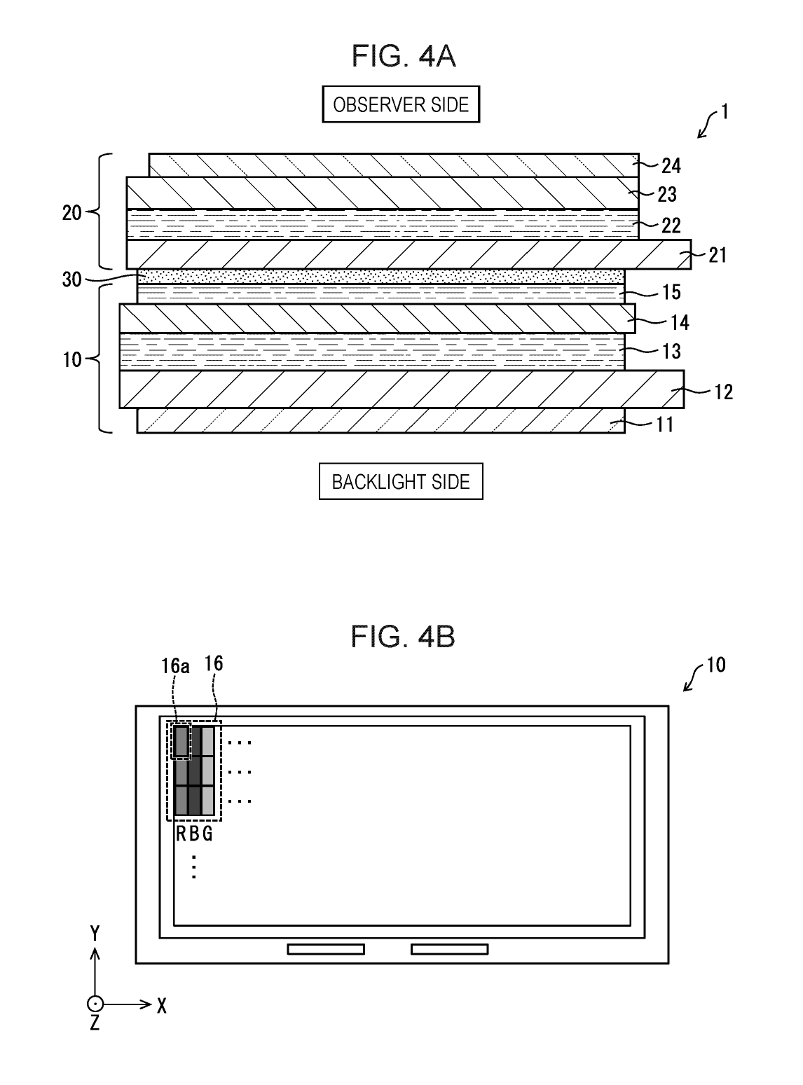

FIG. 4A is a cross-sectional view depicting a schematic configuration of a main portion of the stereoscopic display device 1 according to the present embodiment, and FIG. 4B is a cross-sectional view depicting a schematic configuration of a main portion of the main liquid crystal panel 10 according to the present embodiment.

The stereoscopic display device 1 is a 3D display device of a parallax barrier type (front barrier structure) in which parallax barriers are arranged at the observer side, with which it is possible for a 3D display to be viewed with the naked eye. As depicted in FIG. 4A, the main liquid crystal panel 10 and the switching liquid crystal panel 20 that forms parallax barriers are adhered by means of an adhesive layer 30 in such a way that the switching liquid crystal panel 20 is positioned at the observer side and the main liquid crystal panel 10 is positioned at the backlight 46 side.

The main liquid crystal panel 10 has a configuration in which a polarizer 11, a substrate 12 (active matrix substrate), a liquid crystal layer 13, a substrate 14 (opposing substrate), and a polarizer 15 are laminated in this order from the backlight 46 side. A TFT (thin film transistor) substrate, for example, is used for the substrate 12. A CF (color filter) substrate, for example, is used for the substrate 14. The liquid crystal layer 13 is held between this pair of substrates 12 and 14, which are arranged opposing each other.

The switching liquid crystal panel 20 has a configuration in which a substrate 21 (first substrate, segment substrate), a liquid crystal layer 22, a substrate 23 (second substrate, common substrate), and a polarizer 24 are laminated in this order from the main liquid crystal panel 10 side. The liquid crystal layer 22 is held between the pair of substrates 21 and 23, which are arranged opposing each other.

Consequently, the stereoscopic display device 1 has a configuration in which, in order from the backlight 46 side, the polarizer 11, the substrate 12, the liquid crystal layer 13, the substrate 14, the polarizer 15, the adhesive layer 30, the substrate 21, the liquid crystal layer 22, the substrate 23, and the polarizer 24 are laminated in this order from the backlight 46 side.

Note that a 12.3 type of liquid crystal panel is used for the main liquid crystal panel 10 as an example in the present embodiment. The main liquid crystal panel 10 is provided with a plurality of pixels 16. Each pixel 16 is configured of a plurality of subpixels 16a of R (red), B (blue), and G (green), for example. In the main liquid crystal panel 10, subpixel rows composed of the subpixels 16a of each color of R, B, and G are repeatedly arranged, in this order, side-by-side in the Y-axis direction. The number of pixels of the main liquid crystal panel 10 is, for example, 1920 pixels in the X-axis direction×720 pixels in the Y-axis direction, the pixel pitch of the pixels 16 adjacent in the horizontal direction is 50.7 μm, and the pixel pitch of the pixels 16 adjacent in the vertical direction is 152.1 μm. Furthermore, a normally white TN (twisted nematic) liquid crystal layer is used for the liquid crystal layer 22 of the switching liquid crystal panel 20.

The stereoscopic display device 1 is able to switch between a two-dimensional (2D) display and a three-dimensional (3D) display by means of the switching liquid crystal panel 20. Although not depicted, a plurality of electrodes are formed on each of the substrates 21 and 23. Note that detailed structures of the substrates 21 and 23 and the operation of the switching liquid crystal panel 20 will be described hereinafter. The switching liquid crystal panel 20 manipulates the alignment of liquid crystal molecules in the liquid crystal layer 22 by controlling the potentials of these electrodes.

The stereoscopic display device 1 produces a parallax effect by forming regions (barriers) having a light-shielding state in which light from the main liquid crystal panel 10 is shielded and regions (slits) having a light-transmitting state in which light from the main liquid crystal panel 10 is transmitted, in the switching liquid crystal panel 20 during a three-dimensional display by means of the action between the alignment of the liquid crystal molecules of the liquid crystal layer 22 and the polarizer 24. Meanwhile, in the stereoscopic display device 1, during a two-dimensional display, the entire switching liquid crystal panel 20 enters a light-transmitting state. Note that, here, the light-transmitting state indicates a state having a transmittance of white or equivalent thereto. Furthermore, the light-shielding state indicates a state having a transmittance of black or equivalent thereto.

### <Processing Flow of Stereoscopic Display Device 1 During Three-Dimensional Display>

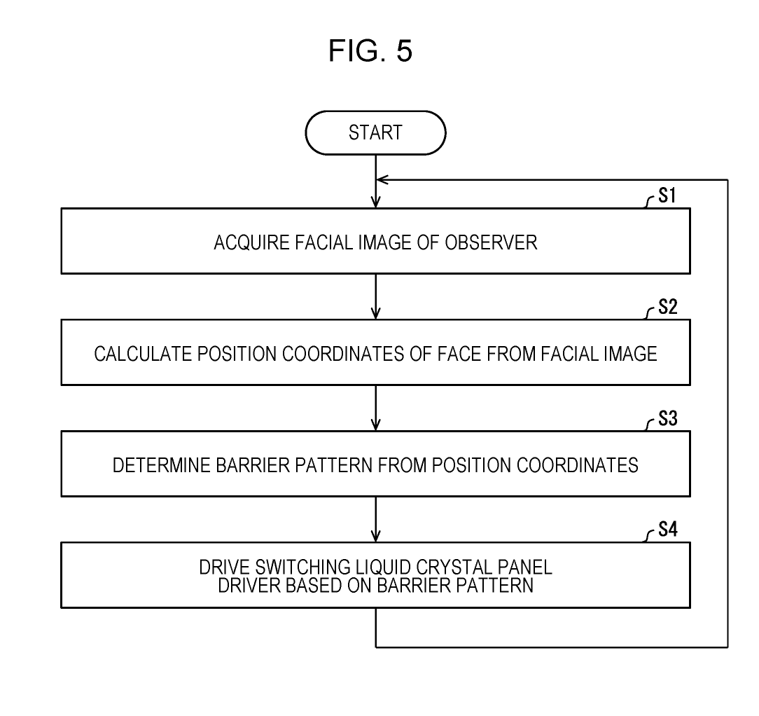

FIG. 5 is flowchart depicting a processing flow of the stereoscopic display device 1 according to the present embodiment.

The stereoscopic display device 1 uses a tracking method in which the barrier pattern of the switching liquid crystal panel 20 is changed in accordance with the movement of the face of the observer. In the stereoscopic display device 1, first, a facial image of the observer is acquired by the camera 41 (step S1). Next, the position detection unit 42 calculates position coordinates (x, y, z) of the face from the facial image (step S2). Thereafter, the display control unit 43 determines, from the position coordinates, a barrier lighting state (barrier pattern) for the switching liquid crystal panel 20 that corresponds to the position coordinates (step S3). In other words, the display control unit 43 determines the positions of barriers and the positions of slits for the switching liquid crystal panel 20 in accordance with the position coordinates of the face of the observer. The switching liquid crystal panel driver 45 drives the switching liquid crystal panel 20 on the basis of the barrier pattern (step S4). Hereinafter, step S1 to step S4 are repeated. The functions of the position detection unit 42 and the display control unit 43 are realized by a processor executing a prescribed program, for example.

### <Configuration of Switching Liquid Crystal Panel 20>

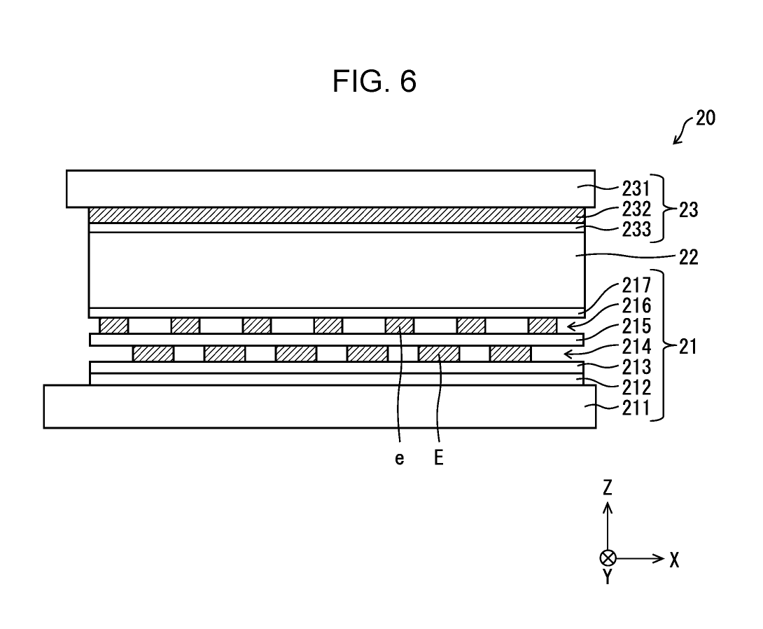

FIG. 6 is a cross-sectional view depicting a schematic configuration of a main portion of the switching liquid crystal panel 20 according to the present embodiment. Note that FIG. 6 does not depict the polarizer 24.

As depicted in FIG. 6, the substrate 21 has a configuration in which an insulating substrate 211, lead wiring line 212, an insulating film 213, a lower electrode layer 214, an insulating film 215 (first insulating film), an upper electrode layer 216, and an alignment film 217 are laminated in this order from the insulating substrate 211 side. The lower electrode layer 214 includes a plurality of electrodes E (segment electrodes, first electrodes, first lower electrodes) as barrier electrodes. The upper electrode layer 216 includes a plurality of electrodes e (segment electrodes, second electrodes, first upper electrodes) as barrier electrodes.

Meanwhile, the substrate 23 has a configuration in which an insulating substrate 231, an electrode 232 (second electrode), and an alignment film 233 are laminated in this order from the insulating substrate 231 side. The electrode 232 is a common electrode in the solid pattern, which is arranged in an opposing manner common to the lower electrode layer 214 and the upper electrode layer 216.

The substrate 21 and the substrate 23 are arranged opposing each other in such a way that the alignment film 217 and the alignment film 233 are adjacent in the Z-axis direction with the liquid crystal layer 22 interposed.

Glass substrates, for example, are used for the insulating substrates 211 and 231. Electrodes that have light-transmitting properties such as ITO (indium tin oxide) electrodes, for example, are used for the lower electrode layer 214, the upper electrode layer 216, and the electrode 232. A metal that has high electrical conductivity such as aluminum is used for the wires 212. An inorganic insulating film such as silicon nitride (SiN), for example, is used for the insulating films 213 and 215. A polyimide, for example, is used for the alignment films 217 and 233.

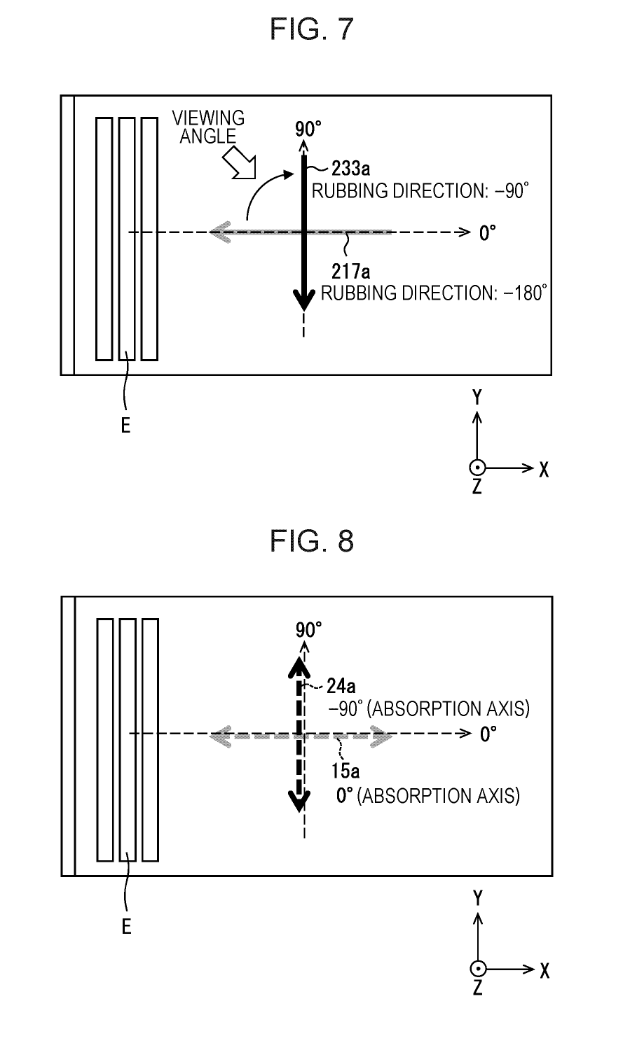

FIG. 7 is an explanatory diagram depicting a rubbing direction of each alignment film 217 and 233 of the switching liquid crystal panel 20 according to the present embodiment.

In FIG. 7, a bidirectional arrow 217a indicates a rubbing direction of the alignment film 217, and a bidirectional arrow 233a indicates a rubbing direction of the alignment film 233. As depicted in FIG. 7, the alignment film 217 and the alignment film 233 rub in directions that intersect each other. Thus, the liquid crystal molecules of the liquid crystal layer 22 adopt a TN alignment in which the alignment direction rotates from the substrate 21 toward the substrate 23 when a voltage is not applied. The alignment film 217 rubs parallel to the arrangement direction of the electrodes E (X-axis direction) in such a way that is orthogonal to the longitudinal direction of the electrodes E (Y-axis direction). Meanwhile, the alignment film 233 rubs parallel to the Y-axis direction in such a way that is orthogonal to the X-axis direction.

FIG. 8 is an explanatory diagram depicting a relationship between an absorption axis 24a of the polarizer 24 of the switching liquid crystal panel 20 according to the present embodiment, and an absorption axis 15a of the polarizer 15 at the switching liquid crystal panel 20 side in the main liquid crystal panel 10.

As depicted in FIG. 8, the polarizer 24 and the polarizer 15 are arranged in such a way that the absorption axis 24a and the absorption axis 15a are orthogonal to each other, and transmittance becomes largest when a voltage is not applied to the liquid crystal layer 22.

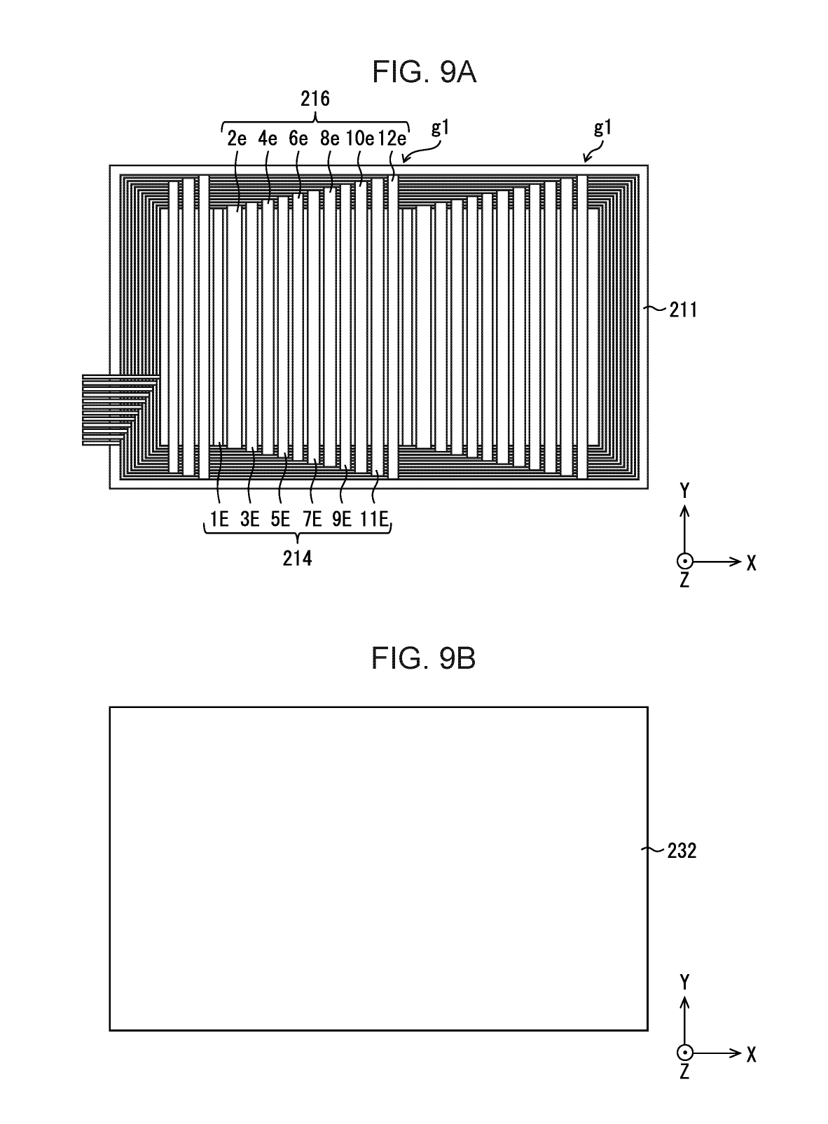

FIG. 9A is a plan view schematically depicting a configuration of a main portion of the substrate 21 of the switching liquid crystal panel 20 according to the present embodiment, and FIG. 9B is a plan view schematically depicting a configuration of a main portion of the substrate 23 of the switching liquid crystal panel 20 according to the present embodiment.

As depicted in FIG. 9A, a plurality of the lead wiring line 212 are provided along the peripheral edge section of the surface of the insulating substrate 211. The electrodes E making up the lower electrode layer 214 are each connected to the lead wiring line 212 via contact holes, which are not depicted, provided in the insulating film 213 (see FIG. 6). Furthermore, the electrodes e in the upper electrode layer 216 are each connected to the lead wiring line 212 via contact holes, which are not depicted, provided in each of the insulating films 213 and 215 (see FIG. 6).

The electrodes E and the electrodes e are arranged in the form of stripes in the X-axis direction so as to be adjacent to each other in the X-axis direction in plan view. Signals for six systems, a total of 12 systems, are supplied from the display control unit 43, via the lead wiring line 212, to the lower electrode layer 214 and the upper electrode layer 216. The lower electrode layer 214 and the upper electrode layer 216 include a plurality of groups g1 in which one group is a group g1 that is composed of barrier electrodes (lower electrode layer 214 and upper electrode layer 216) to which the signals for these 12 systems are supplied.

Hereinafter, in a case where it is desirable to differentiate each of the electrodes E to which signals for six systems from among the 12 systems are supplied in the lower electrode layer 214 of each group g1, these electrodes E will be referred to as electrodes 1E, 3E, 5E, 7E, 9E, and 11E. Furthermore, in a case where it is desirable to mutually differentiate the electrodes e to which signals for six systems from among the 12 systems are supplied in the upper electrode layer 216 of each group g1, these electrodes e will be referred to as electrodes 2e, 4e, 6e, 8e, 10e, and 12e. On the substrate 21, there are formed 12 terminals to which signals for the 12 systems are supplied. The terminals are formed of the same material as the electrodes E and in the same layer as the electrodes E.

Furthermore, as depicted in FIG. 9B, the electrode 232 is a electrode in the solid pattern, and, although not depicted, on the substrate 23, one terminal is formed of the same material as the electrode 232 and in the same layer as the electrode 232.

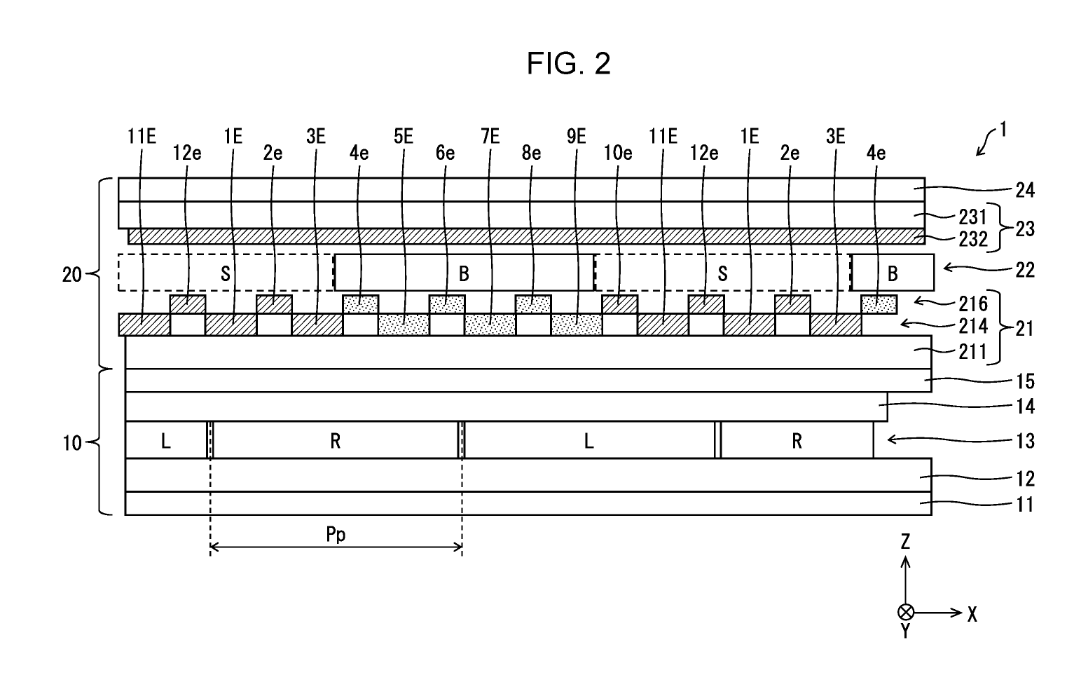

FIG. 1 is a cross-sectional view depicting an enlarged portion of the switching liquid crystal panel 20 in the stereoscopic display device 1 according to the present embodiment. FIG. 2 is a cross-sectional view depicting an example of a configuration of a main portion of the stereoscopic display device 1 according to the present embodiment. Note that some constituent elements are not depicted in FIGS. 1 and 2.

As depicted in FIGS. 1 and 2, the electrodes 1E, 3E, 5E, 7E, 9E, and 11E are arranged periodically in the X-axis direction in this order. Similarly, the electrodes 2e, 4e, 6e, 8e, 10e, and 12e are arranged periodically in the X-axis direction in this order. The electrodes E and the electrodes e, in plan view, are repeatedly arranged one at a time in an alternating manner in the order of electrodes 1E, 2e, 3E, 4e, 5E, 6e, 7E, 8e, 9E, 10e, 11E, and 12e.

As depicted in FIG. 1, each electrode E has a fixed electrode width WL1 in the X-axis direction, and the electrodes E are provided spaced apart from each other by a fixed gap width GL1 in the X-axis direction. Furthermore, each electrode e has a fixed electrode width WU1 in the X-axis direction, and the electrodes e are provided spaced apart from each other by a fixed gap width GU1 in the X-axis direction.

The electrodes e are positioned in a different layer from the electrodes E with the insulating film 215 interposed, and, in plan view, are formed corresponding to the gaps between the electrodes E adjacent in the X-axis direction. The electrodes E, in plan view, are formed corresponding to the gaps between the electrodes e adjacent in the X-axis direction. The gaps between the electrodes e adjacent in the X-axis direction are light-transmitting regions. The lower electrode layer 214 and the upper electrode layer 216 are formed in such a way that the electrodes E and the electrodes e satisfy the relationships WL1=GU1 and WU1=GL1. Therefore, the electrodes E and the electrodes e do not superpose each other in plan view, and the X-axis direction edge sections of each electrode E are positioned on the same lines in plan view as the X-axis direction edge sections near the electrode E of the electrodes e that are adjacent to the electrode E in plan view.

Furthermore, the electrode width WL1 of the electrodes E is greater than the electrode width WU1 of the electrodes e. That is, the lower electrode layer 214 and the upper electrode layer 216 are formed in such a way that the electrodes E and the electrodes e satisfy the relationship WU1=GL1<WL1=GU1. Note that the ratio of the electrode width WL1 of the electrodes E with respect to the electrode width WU1 of the electrodes e may be 2 or less (that is, WL1/WU1≤2). Thus, the barrier widths produced when barriers are lit up can be made to be the same, and therefore a satisfactory display quality can be obtained even if the observation position changes.

An example of the design of the electrodes E and e used in the present embodiment is given in Table 1. Note that the barrier pitch Bp1 given in Table 1 indicates the barrier pitch of a group g1, which is indicated by the total electrode width in the X-axis direction of the electrodes 1E to 12e in each group g1, as depicted in FIG. 1. Consequently, in the example given in Table 1, 101.3184/12=16.8864 μm is the average barrier pitch of the barrier electrodes in one group g1.

TABLE 1

| | | | Barrier | |
|---|---|---|---|---|
| | Electrode | Gap | Pitch | Electrode Width |
| | Width (μm) | (μm) | (μm) | Ratio |
| Electrode e | WU1 = 7.4432 | GU1 = | Bp1 = | WL1/WU1 = 1.27 |
| | | 9.4432 | 101.3184 | |
| Electrode E | WL1 = 9.4432 | GL1 = | | |
| | | 7.4432 | | |

Furthermore, as depicted in FIG. 2, in the main liquid crystal panel 10, pixels L that display a video for the left eye and pixels R that display a video for the right eye are arranged in an alternating manner in the X-axis direction. When an electrode pitch Ep in the X-axis direction of the electrodes E is taken as Ep=WL1+GL1 and an electrode pitch ep in the X-axis direction of the electrodes e is taken as ep=WU1+GU1 as depicted in FIG. 1, Ep=ep. Note that when the pixel pitch in the X-axis direction of the pixels L and the pixels R of the main liquid crystal panel 10 is taken as Pp, for example, Ep=ep=16.8864 μm (3×Ep=3×ep=50.6592 μm) and Pp=50.7 μm.

The display control unit 43 separately applies left eye video signals and right eye video signals according to the pixel type as mentioned above for example, to the main liquid crystal panel 10 by means of the main liquid crystal panel driver 44, and separately displays a left eye video and a right eye video by means of the main liquid crystal panel 10. The display control unit 43 then drives a partial barrier electrode group from among the plurality of barrier electrodes in the groups g1 in a first phase (supplies a signal of a first phase, in other words), and drives the other electrodes in a second phase having the opposite polarity to the first phase (supplies a signal of a second phase, in other words). In FIG. 2, a sandy pattern is applied to the barrier electrodes driven in the first phase to differentiate from the electrodes driven in the second phase. Note that a similar differentiation is implemented also in the drawings used in the description given hereinafter.

In the example depicted in FIG. 2, the switching liquid crystal panel 20 applies a rectangular alternating-current voltage with which the electrodes 4e, 5E, 6e, 7E, 8e, and 9E are set to the first phase, and the other barrier electrodes (electrodes 1E, 2e, 3E, 10e, 11E, and 12e) and the electrode 232 are set to the second phase.

Thus, a potential difference occurs between the electrodes 4e, 5E, 6e, 7E, 8e, and 9E and the electrode 232, and the liquid crystal molecules of the liquid crystal layer 22 between the electrodes 4e, 5E, 6e, 7E, 8e, and 9E and the electrode 232 align in the Z-axis direction. The switching liquid crystal panel 20 is normally white liquid crystal. Therefore, a barrier having a light-shielding state B is formed in the portion in which the electrodes 4e, 5E, 6e, 7E, 8e, and 9E and the electrode 232 are superposed in plan view. However, a potential difference does not occur between the electrodes 1E, 2e, 3E, 10e, 11E, and 12e and the electrode 232. Therefore, the portions in which the electrodes 1E, 2e, 3E, 10e, 11E, and 12e and the electrode 232 are superposed in plan view become slits having a light-transmitting state S.

### <Effects>

Hereinafter, the effects of the stereoscopic display device 1 according to the present embodiment will be described using comparative examples and examples. Note that, in the comparative examples and examples described hereinafter, constituent elements having the same functions as constituent elements in the stereoscopic display device 1 according to the present embodiment are denoted by the same numbers and descriptions thereof are omitted.

### Comparative Example 1

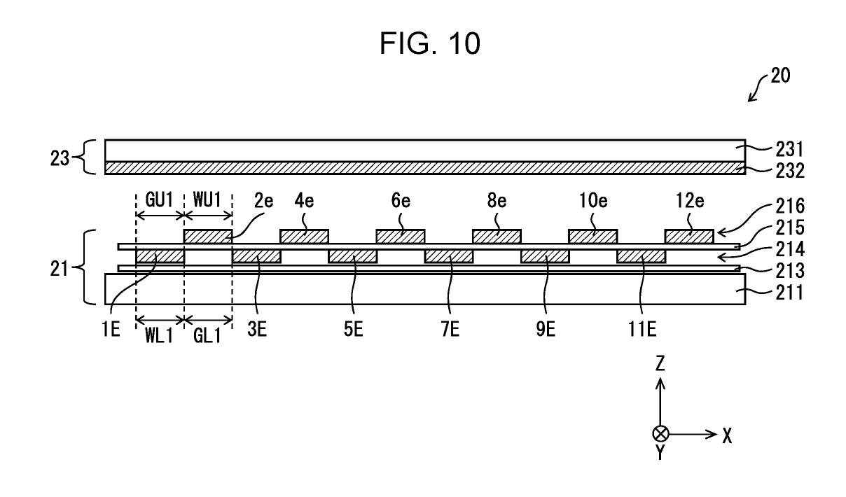

FIG. 10 is a cross-sectional view depicting an enlarged portion of the switching liquid crystal panel 20 in the stereoscopic display device used in the present comparative example. Note that some constituent elements are not depicted in FIG. 10.

The stereoscopic display device according to the present comparative example has the same configuration as the stereoscopic display device 1 according to the present embodiment except that the lower electrode layer 214 and the upper electrode layer 216 are formed in such a way that the electrodes E and the upper electrodes e in the switching liquid crystal panel 20 satisfy GU1=WL1=WU1=GL1, as depicted in FIG. 10. Note that, in the present comparative example, GU1=WL1=WU1=GL1=8.4432 μm.

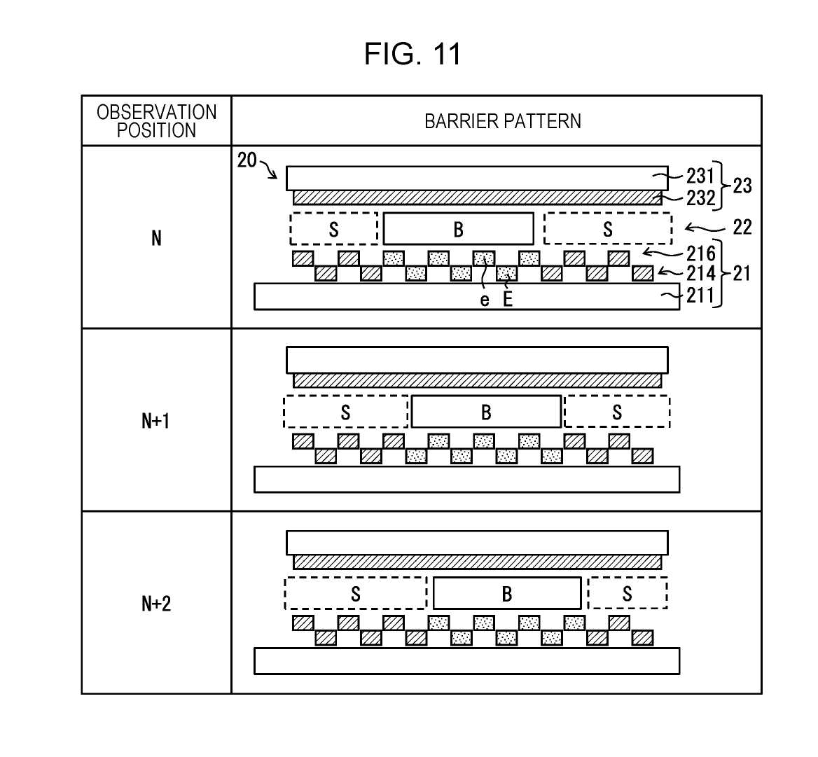

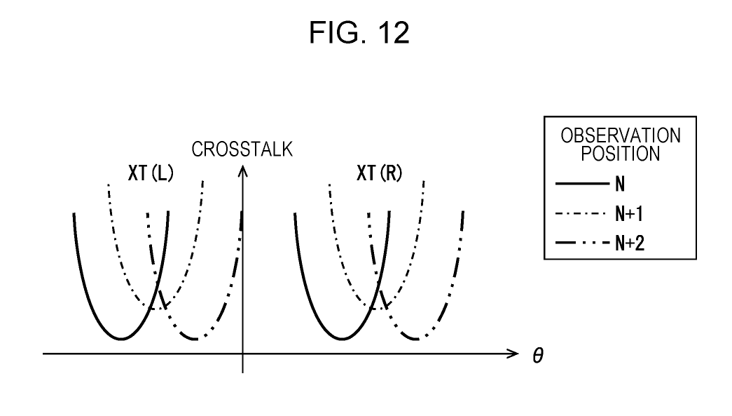

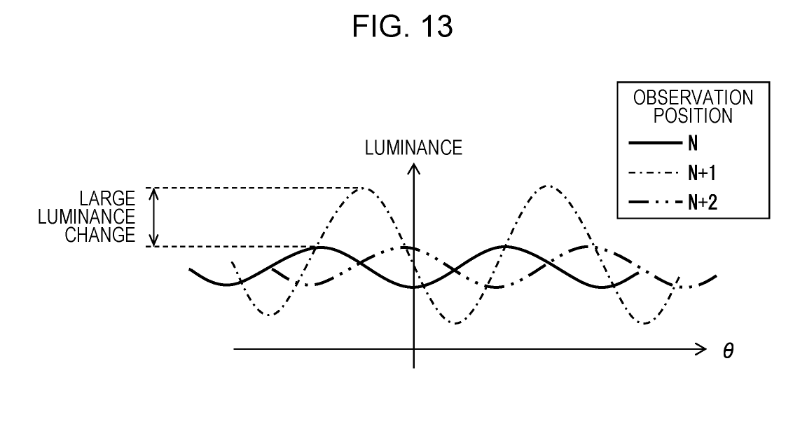

FIG. 11 is an explanatory diagram schematically depicting a relationship between observation positions and barrier patterns of the switching liquid crystal panel 20 in the stereoscopic display device according to the present comparative example. FIG. 12 is a graph depicting angle characteristics for crosstalk in a case where the observation position has been changed as depicted in FIG. 11, in the stereoscopic display device according to the present comparative example. Note that XT(L) indicates crosstalk for the left eye and XT(R) indicates crosstalk for the right eye. Furthermore, FIG. 13 is a graph depicting luminance characteristics in the case where the observation position has been changed as depicted in FIG. 11, in the stereoscopic display device according to the present comparative example.

In the tracking method, the barrier pattern of the switching liquid crystal panel changes in accordance with the movement of the face of the observer. In a case where the electrodes E and the electrodes e are lit up in such a way that a barrier having the light-shielding state B for each group g1 corresponds to an odd number of barrier electrodes (electrodes E and electrodes e) for the barrier pattern as depicted in FIG. 11, a difference in 3D characteristics (crosstalk and luminance changes during a 3D display for the polar angle θ) occurs due to the barrier pattern at the observation position as depicted in FIGS. 12 and 13. Therefore, when the observer has moved, the display quality changes according to the observation position. As a result, the observer experiences a sense of discomfort from, for example, crosstalk (double reflection) or luminance flickering caused by the barrier pattern changing depending on the observation position. A problem in a case where seven barrier electrodes of each group g1 are lit up as depicted in FIG. 11 has been described using FIGS. 12 and 13; however, note that there is a similar problem also in a case where, for example, five barrier electrodes of each group g1 are lit up.

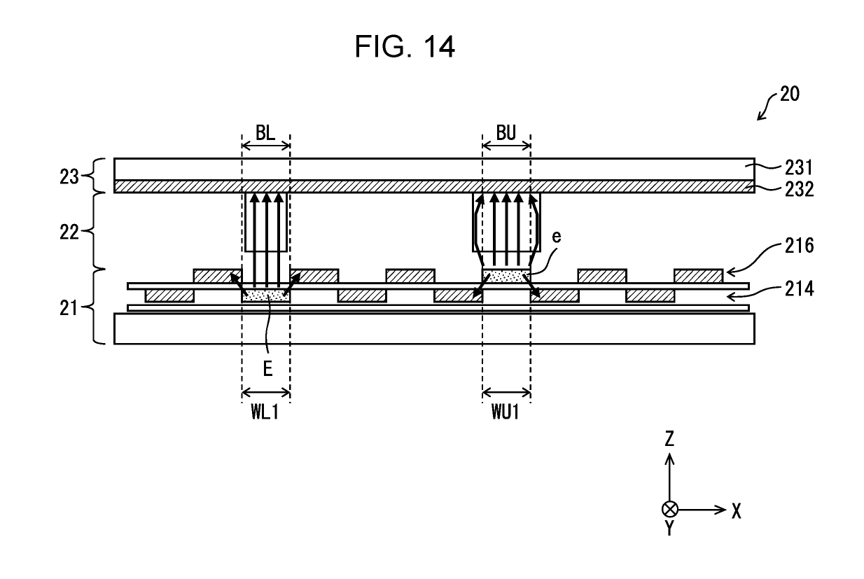

The reason therefor will be described hereinafter with reference to FIG. 14. FIG. 14 is a cross-sectional view schematically depicting a relationship between electrode widths and barrier widths in the X-axis direction of barrier electrodes that light up in the present comparative example.

In a case where barrier electrodes are implemented as multilayer electrodes composed of the electrodes E and the electrodes e as depicted in FIG. 14, when the electrode widths in the X-axis direction of the barrier electrodes are WL1=WU1, a difference occurs in the lines of electric force applied to the liquid crystal layer 22 between when the electrodes e are lit up and the electrodes E are lit up. As a result, the alignment of the liquid crystal molecules changes, and the barrier width in the X-axis direction of the barrier electrodes that light up and the refractive index distribution of the barrier edges changes.

In other words, in a case where the electrodes E are lit up, the electrode width WL1 in the X-axis direction of the electrodes E>the barrier width BL in the X-axis direction of the electrodes E. However, in a case where the electrodes e are lit up, the electrode width WU1 in the X-axis direction of the electrodes e<the barrier width BU in the X-axis direction of the electrodes e. At such time, in the present comparative example, WL1=WU1, and therefore BL<BU. As a result, the aforementioned difference in characteristics occurs due to the barrier pattern.

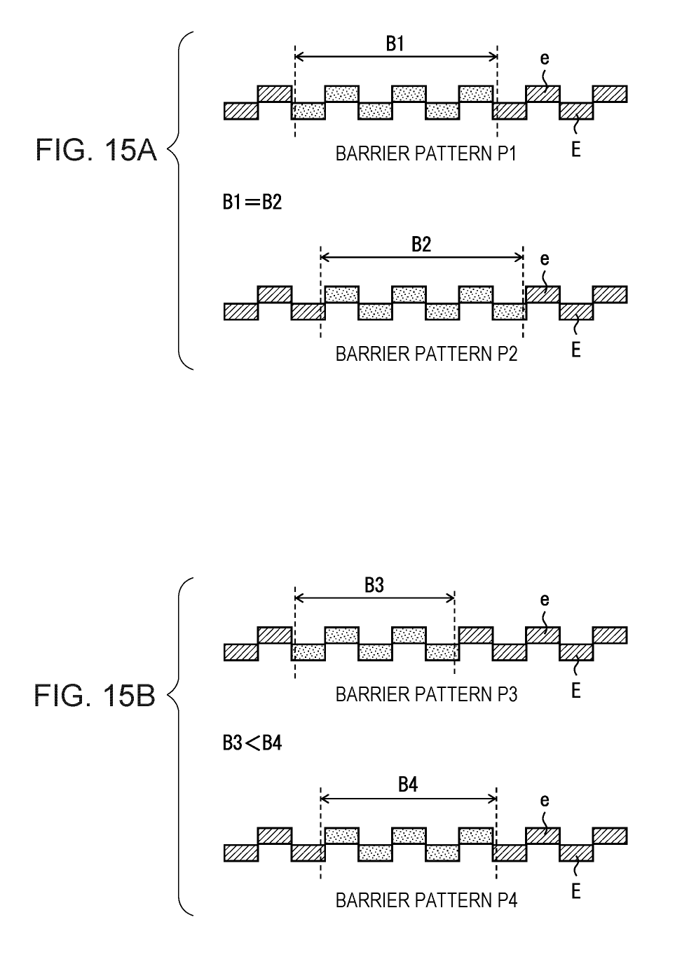

FIG. 15A is an explanatory diagram depicting barrier widths in the X-axis direction in barrier patterns when an even number of barrier electrodes are lit up in the present comparative example, and FIG. 15B is an explanatory diagram depicting barrier widths in the X-axis direction in barrier patterns when an odd number of barrier electrodes are lit up in the present comparative example.

As depicted in FIG. 15A, in a case where the barrier electrodes are driven in an even number of units, even if the barrier pattern changes from P1 to P2 due to a change in the observation position, the number of electrodes E that light up and the number of electrodes e that light up are the same in each of barrier pattern P1 and barrier pattern P2. Specifically, as depicted in FIG. 15A, in a case where six barrier electrodes light up, for example, even if the barrier pattern changes from P1 to P2, the number of electrodes E that light up stays at three and the number of electrodes e that light up also stays at three. Therefore, a barrier width B1 in the X-axis direction in the barrier pattern P1=a barrier width B2 in the X-axis direction in the barrier pattern P2. Consequently, in this case, the aforementioned difference in characteristics does not occur.

However, as depicted in FIG. 15B, in a case where the barrier electrodes are driven in an odd number of units, when the barrier pattern has changed from P3 to P4 due to a change in the observation position, the number of electrodes E that light up and the number of electrodes e that light up change due to the barrier pattern. For example, in the examples depicted in FIG. 15B, three electrodes E light up and two electrodes e light up in barrier pattern P3, whereas two electrodes E light up and three electrodes e light up in barrier pattern P4. Therefore, in a case where WL1=WU1, for the reason described in FIG. 14, a barrier width B3 in the X-axis direction in the barrier pattern P3<a barrier width B4 in the X-axis direction in the barrier pattern P4. Consequently, in this case, the aforementioned difference in characteristics occurs.

The case where six barrier electrodes are lit up is described as an example in FIG. 15A; however, note that a similar result can be obtained also in a case where eight barrier electrodes are lit up. Furthermore, in FIG. 15B, the case where five barrier electrodes are lit up is described as an example; however, note that a similar result can be obtained also in a case where seven barrier electrodes are lit up. In this way, a difference in 3D characteristics occurs when the barrier width in the X-axis direction changes due to the barrier pattern.

Note that, in the present comparative example, one group g1 is formed using 12 barrier electrodes as in the present embodiment, and therefore the number of divisions of the barrier electrodes of one group g1 is 12. However, in a case where the barrier electrodes of one group g1 have an odd number of divisions (13 divisions, for example), even when an even number (six in total, for example) of the barrier electrodes of each group g1 are lit up, the aforementioned difference in characteristics occurs due to the observation position (the barrier pattern, in other words).

### Comparative Example 2

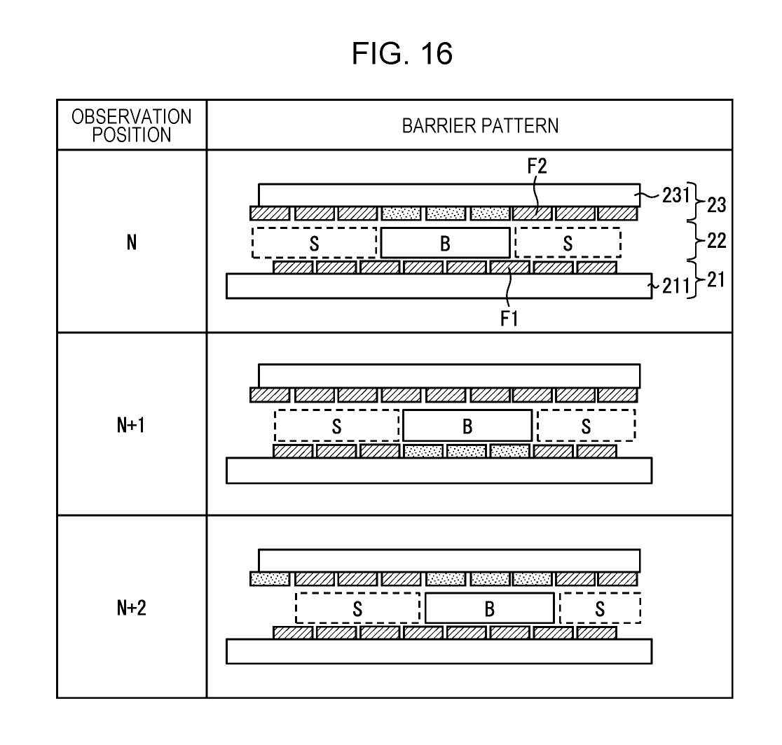

FIG. 16 is an explanatory diagram schematically depicting a relationship between observation positions and barrier patterns of the switching liquid crystal panel 20 in the stereoscopic display device according to the present comparative example.

The stereoscopic display device according to the present comparative example has the same configuration as the stereoscopic display device 1 according to the present embodiment except for using a switching liquid crystal panel according to the International Publication No. 2014/136610 pamphlet, depicted in FIG. 16, as the switching liquid crystal panel 20. The switching liquid crystal panel 20 according to the present comparative example has a configuration in which the substrate 21 is provided with a plurality of electrodes F1 (segment electrodes) instead of the lower electrode layer 214, the insulating film 215, and the upper electrode layer 216, and the substrate 23 is provided with a plurality of electrodes F2 (segment electrodes) instead of the electrode 232. Note that the electrodes F1 and the electrodes F2 have the same electrode width in the X-axis direction, and are arranged mutually offset in the X-axis direction.

Using the aforementioned stereoscopic display device, in a case where the observation position is changed as depicted in FIG. 16, although not depicted, a difference in 3D characteristics similar to that in FIGS. 11 and 12 occurs due to the barrier patterns in the observation positions, and light leakage occurs in the barrier portions due to there being gaps between adjacent electrodes F1 and adjacent electrodes F2.

### Example 1

In contrast, according to the present embodiment, for example, by implementing WU1=GL1<WL1=GU1 as depicted in FIG. 1, light leakage does not occur, there is no difference in characteristics caused by the barrier pattern, and it becomes possible to maintain a satisfactory display quality.

Hereinafter, an effect in a case where the aforementioned stereoscopic display device 1 according to the present embodiment is used as the stereoscopic display device 1 will be described by comparing comparative example 1 and comparative example 2.

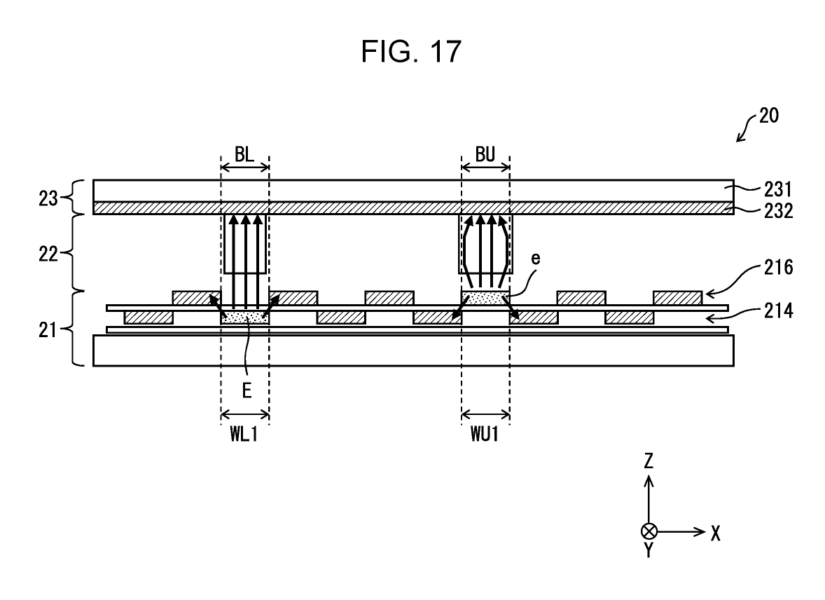

FIG. 17 is a cross-sectional view schematically depicting a relationship between electrode widths and barrier widths in the X-axis direction of barrier electrodes that light up in the present example.

By implementing barrier electrodes as multilayer electrodes composed of the electrodes E and the electrodes e also in the present example as depicted in FIG. 17, a difference occurs in the lines of electric force applied to the liquid crystal layer 22 between when the electrodes e are lit up and when the electrodes E are lit up. In other words, in a case where the electrodes E are lit up, the electrode width WL1 in the X-axis direction of the electrodes E>the barrier width BL in the X-axis direction of the electrodes E. However, in a case where the electrodes e are lit up, the electrode width WU1 in the X-axis direction of the electrodes e<the barrier width BU in the X-axis direction of the electrodes e. However, in the present example, the electrode width of the barrier electrodes in the X-axis direction is WU1=GL1<WL1=GU1, and therefore it is possible to implement BL=BU.

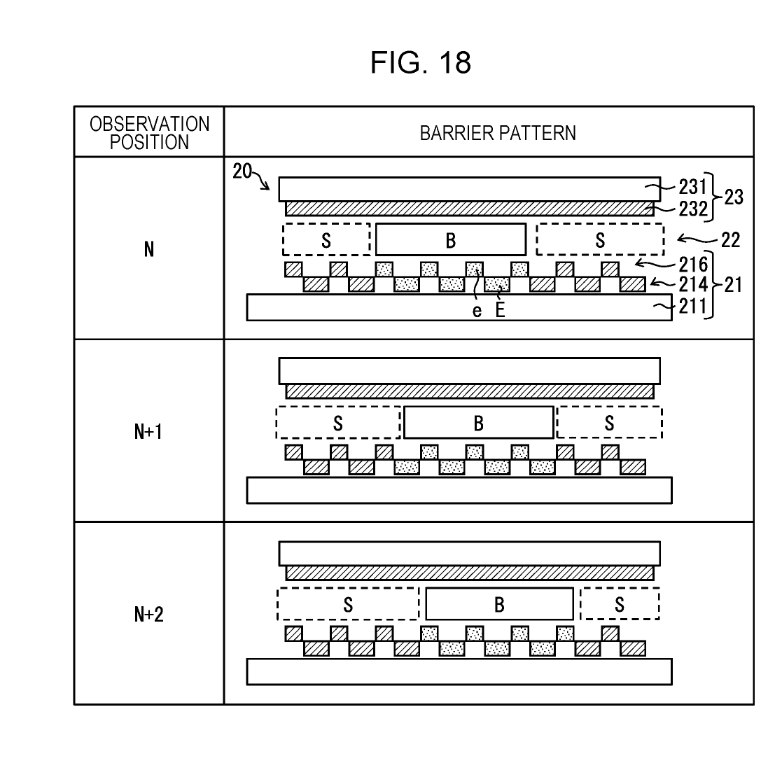

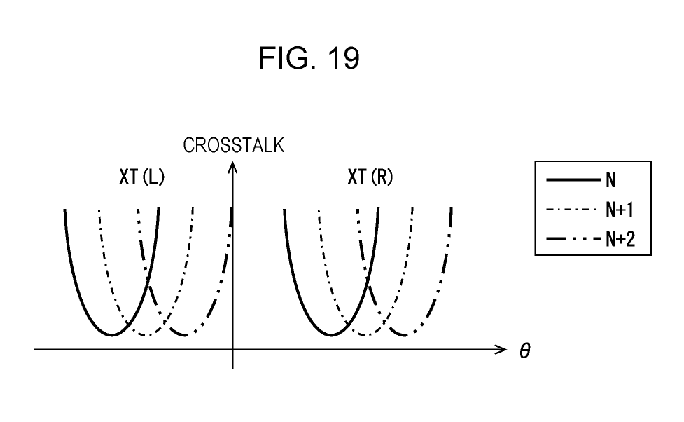

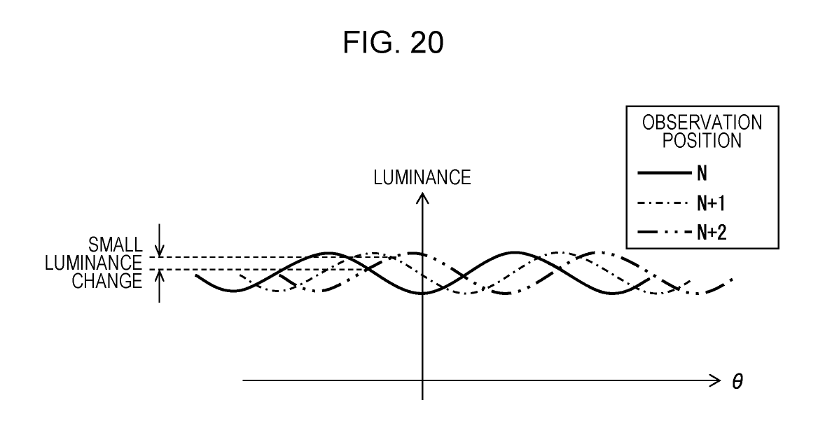

FIG. 18 is an explanatory diagram schematically depicting a relationship between observation positions and barrier patterns of the switching liquid crystal panel 20 in the stereoscopic display device 1 according to the present example. FIG. 19 is a graph depicting angle characteristics for crosstalk in a case where the observation position has been changed as depicted in FIG. 18, in the stereoscopic display device 1 according to the present example. Furthermore, FIG. 20 is a graph depicting luminance characteristics in the case where the observation position has been changed as depicted in FIG. 18, in the stereoscopic display device 1 according to the present example.

According to the present example, as depicted in FIG. 17, the barrier width in the X-axis direction in a case where the electrodes E are lit up and the barrier width in the X-axis direction in a case where the electrodes e are lit up can be made to be the same. Therefore, even in a case where an odd number of barrier electrodes have been lit up, or a case where the barrier electrodes of one group g1 have an odd number of divisions (13 divisions, for example), a barrier width in the X-axis direction produced by the barrier electrode group that is lit up can be made to be the same before and after a change in the observation position caused by movement of the face of the observer.

Therefore, according to the present example, even if the observation position has changed and the barrier pattern has changed, the difference in 3D characteristics is small as depicted in FIGS. 19 and 20, and a satisfactory 3D display quality can be obtained.

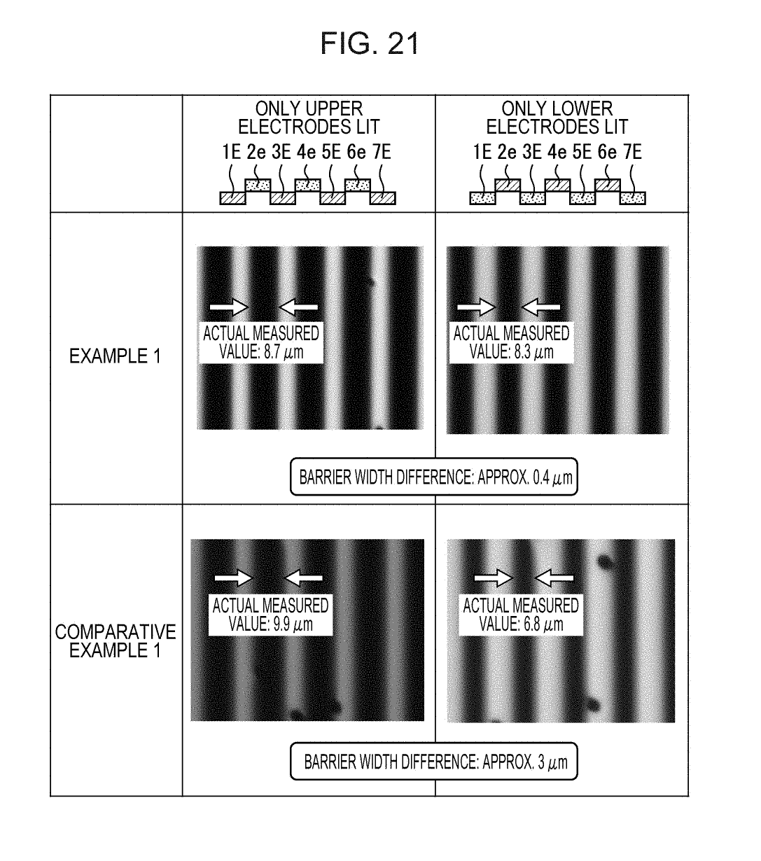

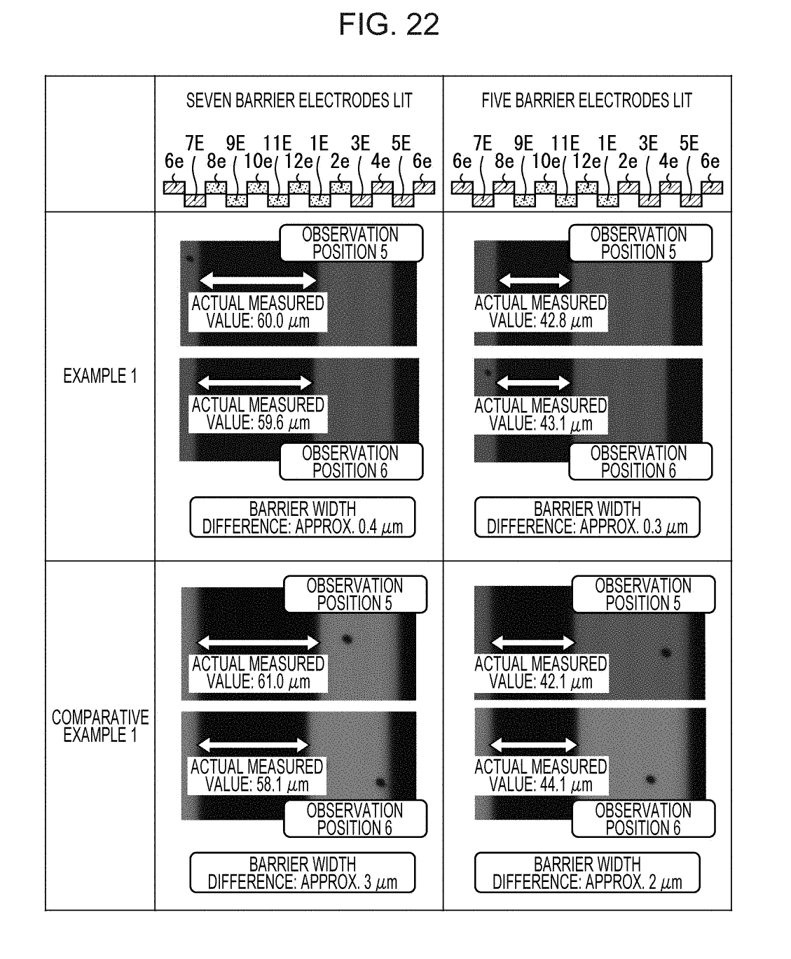

FIG. 21 is a drawing depicting actual measurement results for barrier widths in the X-axis direction, using an electron micrograph, in a case where only the electrodes e have been lit up and in a case where only the electrodes E have been lit up, in the present example and comparative example 1. FIG. 22 is a drawing depicting actual measurement results for barrier widths in the X-axis direction, using an electron micrograph, in observation position 5 and observation position 6, in a case where seven barrier electrodes have been lit up and in a case where five barrier electrodes have been lit up, in the present example and comparative example 1. Note that, in either case, a rectangular alternating-current voltage of a drive frequency of 60 Hz is applied to the barrier electrodes. Furthermore, the drive voltage of the barrier electrodes is 5 V. Note that observation positions (barrier positions), in FIG. 22, are arranged side-by-side in the order of observation position 1 to observation position 12 in the right-left direction. As depicted in FIGS. 21 and 22, according to the present example, it is clear that the barrier width difference in the X-axis direction is improved (small, in other words) compared to the comparative example 1.

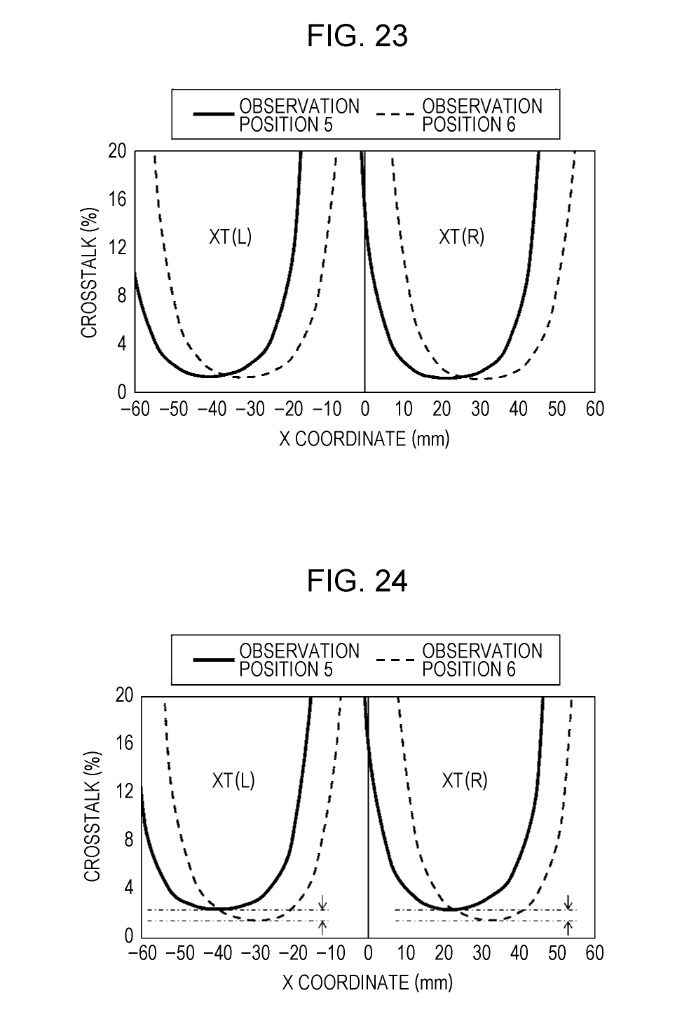

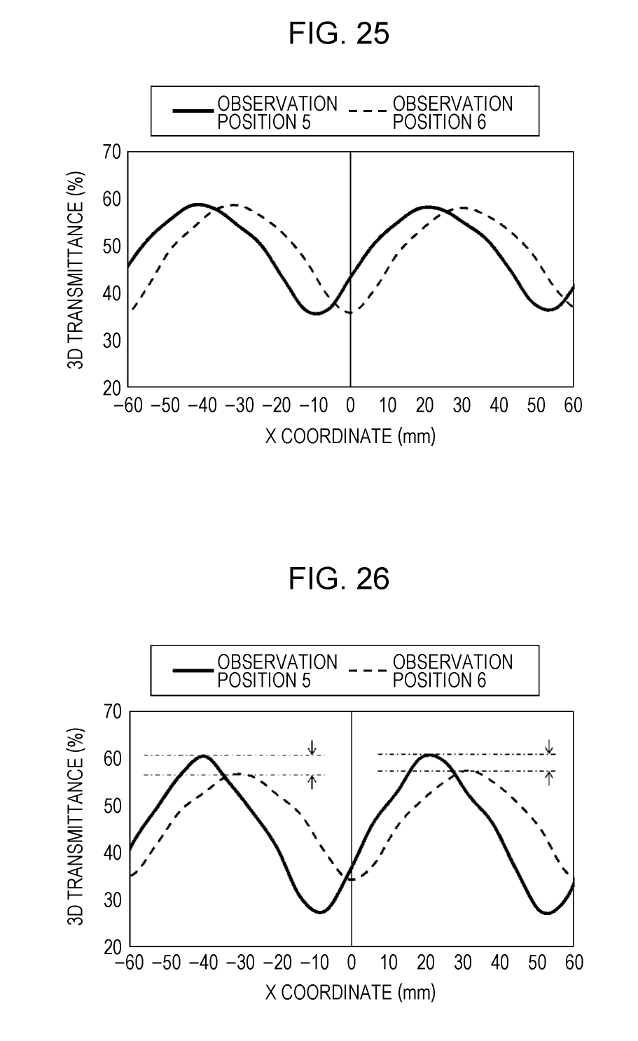

Furthermore, FIG. 23 is a graph depicting actual measurement results for crosstalk in observation position 5 and observation position 6 when an odd number of barrier electrodes have been lit up in the stereoscopic display device 1 according to the present example. FIG. 24 is a graph depicting actual measurement results for crosstalk in observation position 5 and observation position 6 when an odd number of barrier electrodes have been lit up in the stereoscopic display device according to comparative example 1. FIG. 25 is a graph depicting actual measurement results for luminance distributions in observation position 5 and observation position 6 when an odd number of barrier electrodes have been lit up in the stereoscopic display device 1 according to the present example. FIG. 26 is a graph depicting actual measurement results for luminance distributions in observation position 5 and observation position 6 when an odd number of barrier electrodes have been lit up in the stereoscopic display device according to comparative example 1. In either case, a rectangular alternating-current voltage of a drive frequency of 60 Hz is applied to the barrier electrodes. Furthermore, the drive voltage of the barrier electrodes is 5 V, and the number of lit-up barrier electrodes is seven in both cases. Note that, in FIGS. 23 to 26, the center coordinates in the X-axis direction are observation position 6. Furthermore, in FIGS. 23 and 24, XT(L) indicates crosstalk for the left eye and XT(R) indicates crosstalk for the right eye.

According to comparative example 1, between observation position 5 and observation position 6, there is a difference in characteristics for crosstalk indicated by the arrows in FIG. 24, whereas, according to the present example, as depicted in FIG. 23, it is clear that there is no difference in characteristics for crosstalk caused by a difference in observation position. Furthermore, according to comparative example 1, between observation position 5 and observation position 6, there is a difference in luminance (3D transmittance) indicated by the arrows in FIG. 26, whereas, according to the present example, as depicted in FIG. 25, it is clear that there is no difference in characteristics for luminance (3D transmittance) and there is no luminance flickering caused by a difference in observation position.

As mentioned above, in comparative example 1, optical characteristics differ greatly in each observation position, which is connected to a deterioration in display quality; however, according to the stereoscopic display device 1 of the present example, there are no differences in characteristics caused by a change in the barrier pattern accompanying a change in the observation position, and it becomes possible to maintain a satisfactory display quality.

Furthermore, according to the present embodiment, different from comparative example 2, it is possible to switch between barriers and slits with the electrodes E and e at the substrate 21 side. Furthermore, according to the present embodiment, the layer configuration of the substrate 23 can be simplified compared to the switching liquid crystal panel 20 according to embodiment 2 described hereinafter.

### Modified Example

A normally white liquid crystal layer is used for the liquid crystal layer 22 of the switching liquid crystal panel 20 in the present embodiment; however, note that a normally black liquid crystal layer may be used. Furthermore, a case where a liquid crystal panel (main liquid crystal panel 10) is used for a display panel has been described as an example in the present embodiment; however, the type of display panel is not particularly restricted. Various types of publicly known display panels can be used for the display panel, such as an organic EL (electroluminescence) panel, an inorganic EL panel, a QLED (quantum dot light-emitting diode) panel, or a plasma display panel, for example. Furthermore, the switching liquid crystal panel 20 can also be arranged at the backlight 46 side of the main liquid crystal panel 10. Note that the backlight 46 is not necessary in a case where the display panel is a self-light-emitting display panel such as an organic EL panel, an inorganic EL panel, or a QLED panel.

### Embodiment 2

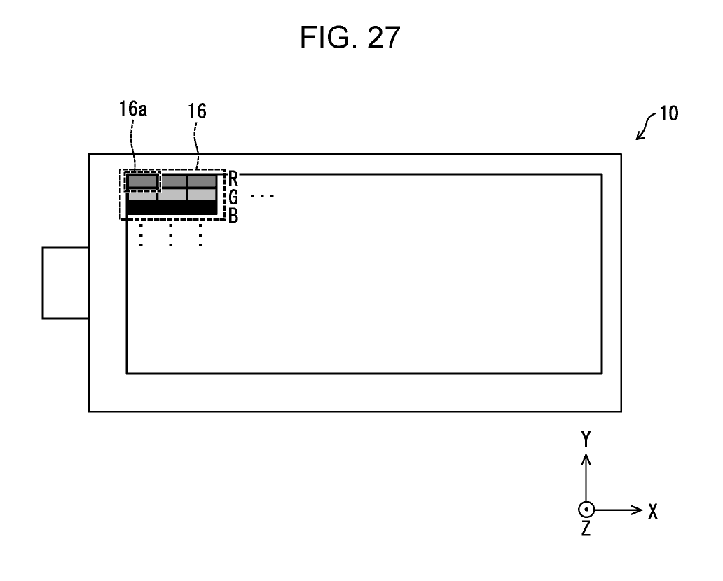

Another embodiment of the present disclosure is as follows when described based on FIGS. 27 to 33A and B. Note that, for the convenience of the description, constituent elements having the same function as the constituent elements described in embodiment 1 are denoted by the same reference numbers and descriptions thereof are omitted.

### <Schematic Configuration of Stereoscopic Display Device 1>

The stereoscopic display device 1 according to the present embodiment has the same schematic configuration as the schematic configuration depicted in FIGS. 3 and 4A. However, the stereoscopic display device 1 according to the present embodiment is different from the stereoscopic display device 1 according to embodiment 1 with regard to the points described hereinafter.

FIG. 27 is a plan view depicting a schematic configuration of a main portion of the main liquid crystal panel 10 according to the present embodiment.

A 6.4 type of liquid crystal panel is used for the main liquid crystal panel 10 as an example in the present embodiment. In the main liquid crystal panel 10, subpixel rows composed of the subpixels 16a of each color of R, B, and G are repeatedly arranged, in this order, side-by-side in the X-axis direction. The number of pixels of the main liquid crystal panel 10 is, for example, 1920 pixels in the X-axis direction×1080 pixels in the Y-axis direction, the pixel pitch of the pixels 16 adjacent in the horizontal direction is 74.25 μm, and the pixel pitch of the pixels 16 adjacent in the vertical direction is 24.75 μm. Note that, also in the present embodiment, a normally white TN liquid crystal layer is used for the liquid crystal layer 22 of the switching liquid crystal panel 20.

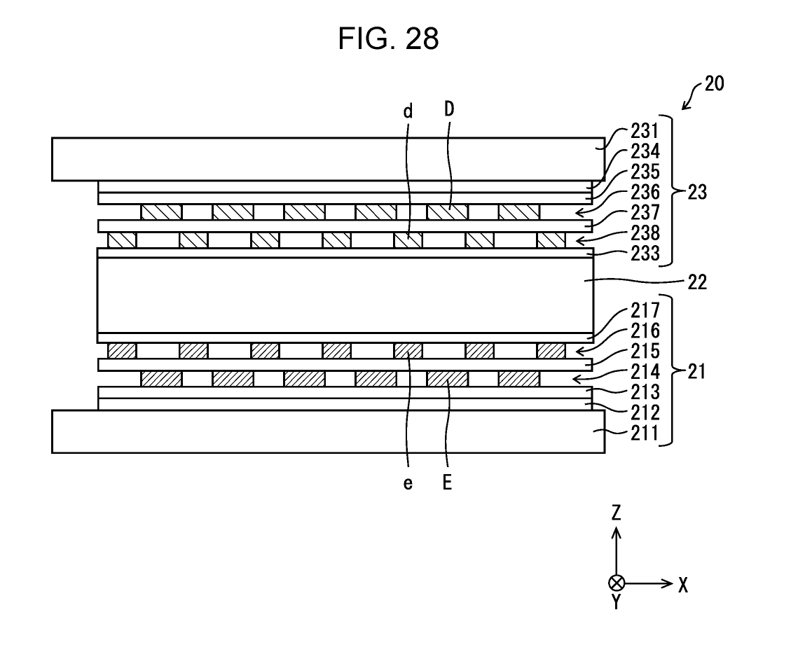

FIG. 28 is a cross-sectional view depicting a schematic configuration of a main portion of the switching liquid crystal panel 20 according to the present embodiment. Note that FIG. 28 does not depict the polarizer 24.

In the switching liquid crystal panel 20 according to the present embodiment, the substrate 23 is different from the substrate 23 according to embodiment 1 in having a configuration in which the insulating substrate 231, lead wiring line 234, an insulating film 235, a lower electrode layer 236, an insulating film 237 (second insulating film), an upper electrode layer 238, and the alignment film 233 are laminated in this order from the insulating substrate 231 side. The lower electrode layer 236 includes a plurality of electrodes D (segment electrodes, second electrodes, second lower electrodes) as barrier electrodes. The upper electrode layer 238 includes a plurality of electrodes d (segment electrodes, second electrodes, second upper electrodes) as barrier electrodes.

A material similar to that of the lead wiring line 212 can be used for the lead wiring line 234. A material similar to that of the insulating films 213 and 215 can be used for the insulating films 235 and 237. Furthermore, the rubbing directions of the alignment films 217 and 233 of the switching liquid crystal panel 20 and the relationship between the absorption axis 24a of the polarizer 24 of the switching liquid crystal panel 20 and the absorption axis 15a of the polarizer 15 at the switching liquid crystal panel 20 side in the main liquid crystal panel 10 are the same as in the switching liquid crystal panel 20 according to embodiment 1.

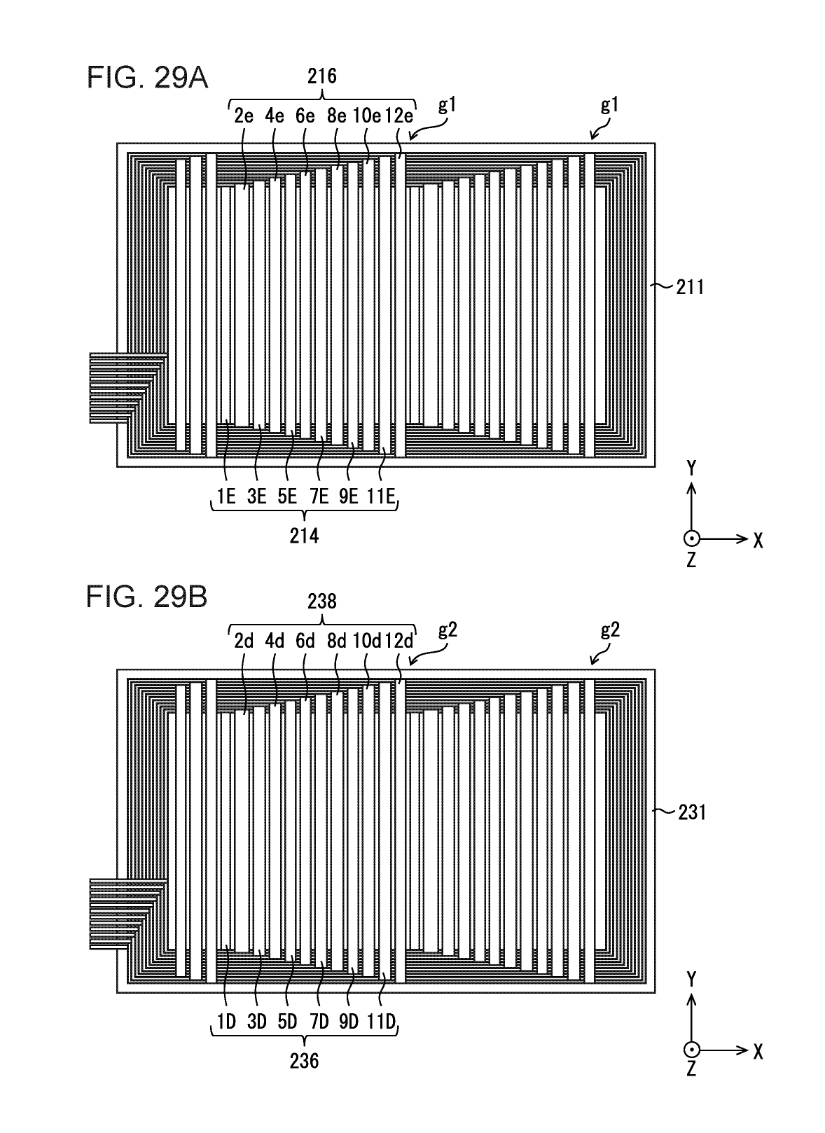

FIG. 29A is a plan view schematically depicting a configuration of a main portion of the substrate 21 of the switching liquid crystal panel 20 according to the present embodiment, and FIG. 29B is a plan view schematically depicting a configuration of a main portion of the substrate 23 of the switching liquid crystal panel 20 according to the present embodiment. Note that the configuration of the main portion of the substrate 21 depicted in FIG. 29A is the same as the configuration of the main portion of the substrate 21 depicted in FIG. 9A. Therefore, a description of the configuration of the main portion of the substrate 21 is omitted.

As depicted in FIG. 29B, a plurality of the lead wiring line 234 are provided along the peripheral edge section of the surface of the insulating substrate 231. The electrodes D making up the lower electrode layer 236 are each connected to the lead wiring line 234 via contact holes, which are not depicted, provided in the insulating film 235 (see FIG. 28). Furthermore, the electrodes d in the upper electrode layer 238 are each connected to the lead wiring line 234 via contact holes, which are not depicted, provided in each of the insulating films 235 and 237 (see FIG. 28).

The electrodes D and the electrodes d are arranged in the form of stripes in the X-axis direction so as to be adjacent to each other in the X-axis direction in plan view. Signals for six systems, a total of 12 systems, are supplied from the display control unit 43, via the lead wiring line 234, to the lower electrode layer 236 and the upper electrode layer 238. The lower electrode layer 236 and the upper electrode layer 238 include a plurality of groups g2 in which one group is a group g2 composed of barrier electrodes (lower electrode layer 236 and upper electrode layer 238) to which the signals for these 12 systems are supplied.

Hereinafter, in a case where it is desirable to differentiate each of the electrodes D to which signals for six systems from among the 12 systems are supplied in the lower electrode layer 236 of each group g2, these electrodes D will be referred to as electrodes 1D, 3D, 5D, 7D, 9D, and 11D. Furthermore, in a case where it is desirable to differentiate each of the electrodes d to which signals for six systems from among the 12 systems are supplied in the upper electrode layer 238 of each group g2, these electrodes d will be referred to as electrodes 2d, 4d, 6d, 8d, 10d, and 12d. On the substrate 23, there are formed 12 terminals to which signals for the 12 systems are supplied. The terminals are formed of the same material as the electrodes D and in the same layer as the electrodes D.

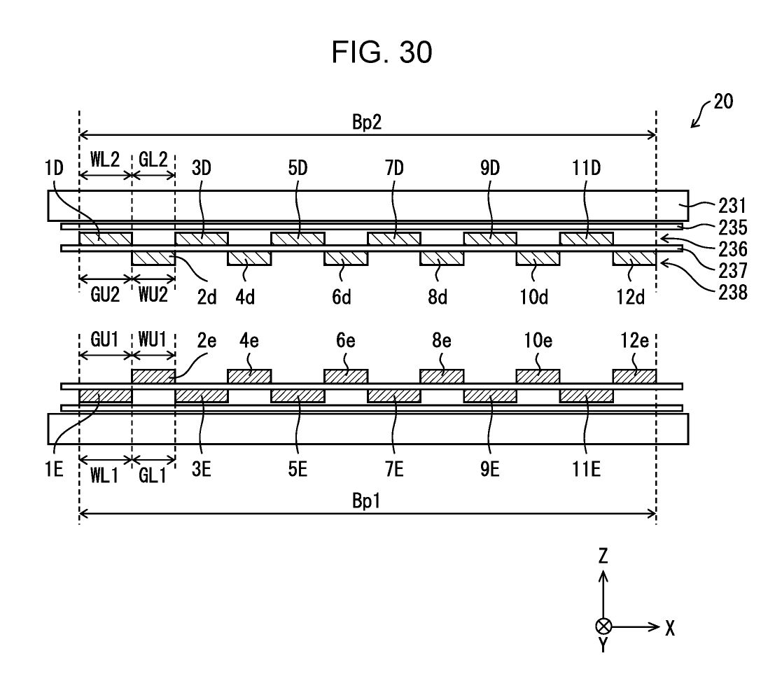

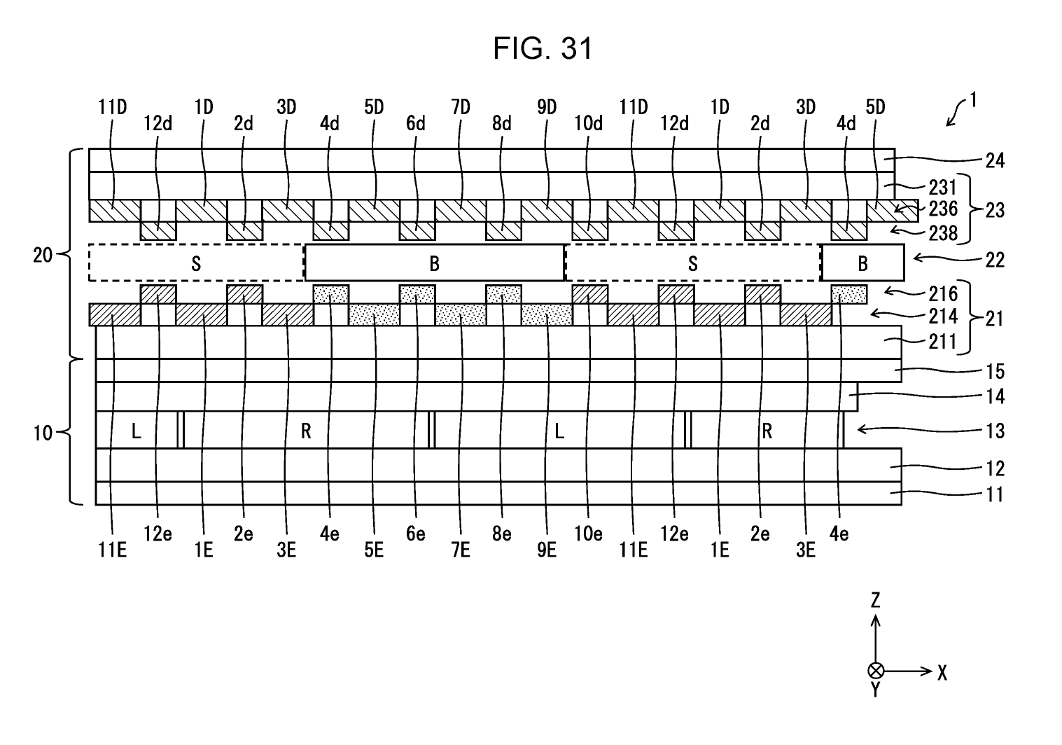

FIG. 30 is a cross-sectional view depicting an enlarged portion of the switching liquid crystal panel 20 in the stereoscopic display device 1 according to the present embodiment. FIG. 31 is a cross-sectional view depicting an example of a configuration of a main portion of the stereoscopic display device 1 according to the present embodiment. Note that some constituent elements are not depicted in FIGS. 30 and 31.

As depicted in FIGS. 30 and 31, the electrodes 1D, 3D, 5D, 7D, 9D, and 11D are arranged periodically in the X-axis direction in this order. Similarly, the electrodes 2d, 4d, 6d, 8d, 10d, and 12d are arranged periodically in the X-axis direction in this order. The electrodes D and the electrodes d, in plan view, are repeatedly arranged one at a time in an alternating manner in the order of electrodes 1D, 2d, 3D, 4d, 5D, 6d, 7D, 8d, 9D, 10d, 11D, and 12d.

As depicted in FIG. 30, each electrode D has a fixed electrode width WL2 in the X-axis direction, and the electrodes D are provided spaced apart from each other by a fixed gap width GL2 in the X-axis direction. Furthermore, each electrode d has a fixed electrode width WU2 in the X-axis direction, and the electrodes d are provided spaced apart from each other by a fixed gap width GU2 in the X-axis direction.

The electrodes d are positioned in a different layer from the electrodes D with the insulating film 237 interposed, and, in plan view, are formed corresponding to gaps between adjacent electrodes D. The electrodes D, in plan view, are formed corresponding to gaps between the electrodes d adjacent in the X-axis direction. The gaps between the electrodes d adjacent in the X-axis direction are light-transmitting regions. The lower electrode layer 236 and the upper electrode layer 238 are formed in such a way that the electrodes D and the electrodes d satisfy the relationships WL2=GU2 and WU2=GL2. Therefore, the electrodes D and the electrodes d do not superpose each other in plan view, and the X-axis direction edge sections of each electrode D are positioned on the same lines in plan view as the X-axis direction edge sections near the electrode D of the electrodes d that are adjacent to the electrode D in plan view.

Furthermore, the electrode width WL2 in the X-axis direction of the electrodes D is greater than the electrode width WU2 in the X-axis direction of the electrodes d. That is, the lower electrode layer 236 and the upper electrode layer 238 are formed in such a way that the electrodes D and the electrodes d satisfy the relationship WU2=GL2<WL2=GU2. Note that the ratio of the electrode width WL2 of the electrodes D with respect to the electrode width WU2 of the electrodes d may be 2 or less (that is, WL2/WU2≤2). Thus, the barrier widths produced when barriers are lit up can be made to be the same, and therefore a satisfactory display quality can be obtained even if the observation position changes.

The electrodes E, e, D, and d are arranged in an opposing manner in such a way that the groups g1 and the groups g2 superpose each other in plan view. That is, the electrodes E, e, D, and d are arranged in such a way that the electrode 1E and the electrode 1D, the electrode 2e and the electrode 2d, the electrode 3E and the electrode 3D, the electrode 4e and the electrode 4d, the electrode 5E and the electrode 5D, the electrode 6e and the electrode 6d, the electrode 7E and the electrode 7D, the electrode 8e and the electrode 8d, the electrode 9E and the electrode 9D, the electrode 10e and the electrode 10d, the electrode 11E and the electrode 11D, and the electrode 12e and the electrode 12d are respectively superposed in plan view.

When an electrode pitch Dp in the X-axis direction of the electrodes D is taken as Dp=WL2+GL2 and an electrode pitch dp in the X-axis direction of the electrodes d is taken as dp=WU2+GU2, Dp=dp. Note that, also in the present embodiment, the electrodes E and the electrodes e, as in embodiment 1, are formed in such a way that the relationships WU1=GL1<WL1=GU1 and WL1/WU1≤2 are satisfied, and Ep=ep. However, WL1≠WL2, WU1≠WU2, GL1≠GL2, and GU1≠GU2, and specifically, for example, WU1=GL1<WU2=GL2<WL1=GU1<WL2=GU2. Thus, the barrier widths produced when barriers are lit up can be made to be the same, and therefore a satisfactory display quality can be obtained even if the observation position changes, and, compared to embodiment 1, it is possible to enlarge the region (degree of freedom) in the Z-axis direction that is stereoscopically viewable. However, the present embodiment is not restricted thereto, and WU1=GL1>WU2=GL2>WL1=GU1>WL2=GU2 may be implemented.

An example of the design of the electrodes E, e, D, and d used in the present embodiment is given in Table 2. Note that the barrier pitch Bp1 given in Table 2 indicates the barrier pitch of a group g1, which is indicated by the total electrode width in the X-axis direction of the electrodes 1E to 12e in each group g1, as depicted in FIG. 30. Furthermore, the barrier pitch Bp2 indicates the barrier pitch of a group g2, which is indicated by the total electrode width in the X-axis direction of the electrodes 1D to 12d in each group g2, as depicted in FIG. 30. Consequently, in the example given in Table 2, 148.368/12=12.364 μm is the average barrier pitch of the barrier electrodes in one group g1. Furthermore, 148.332/12=12.361 μm is the average barrier pitch of the barrier electrodes in one group g2.

TABLE 2

| | Electrode | | Barrier Pitch | Electrode |
|---|---|---|---|---|
| | Width (μm) | Gap (μm) | (μm) | Width Ratio |
| Electrode d | WU2 = 11.364 | GU2 = | Bp1 = | WL2/WU2 = |
| | | 13.364 | 148.368 | 1.18 |
| Electrode D | WL2 = 13.364 | GL2 = | | |
| | | 11.364 | | |
| Electrode e | WU1 = 11.361 | GU1 = | Bp2 = | WL1/WU1 = |
| | | 13.361 | 148.332 | 1.17 |
| Electrode E | WL1 = 13.361 | GL1 = | | |
| | | 11.361 | | |

In the example depicted in FIG. 31, the switching liquid crystal panel 20 applies a rectangular alternating-current voltage with which the electrodes 4e, 5E, 6e, 7E, 8e, and 9E are set to the first phase, and the other barrier electrodes (electrodes 1E, 2e, 3E, 10e, 11E, 12e, 1D, 2d, 3D, 4d, 5D, 6d, 7D, 8d, 9D, 10d, 11D, and 12d) are set to the second phase.

Thus, a potential difference occurs between the electrodes 4e, 5E, 6e, 7E, 8e, and 9E and the electrodes 4d, 5D, 6d, 7D, 8d, and 9D that oppose the aforementioned electrodes, and the liquid crystal molecules of the liquid crystal layer 22 between the electrodes 4e, 5E, 6e, 7E, 8e, and 9E and the electrodes 4d, 5D, 6d, 7D, 8d, and 9D align in the Z-axis direction. The switching liquid crystal panel 20 is normally white liquid crystal. Therefore, a barrier having a light-shielding state B is formed in the portion in which the electrodes 4e, 5E, 6e, 7E, 8e, and 9E and the electrodes 4d, 5D, 6d, 7D, 8d, and 9D are superposed in plan view. Meanwhile, a potential difference does not occur between the electrodes 1E, 2e, 3E, 10e, 11E, and 12e and the electrodes 1D, 2d, 3D, 10d, 11D, and 12d. Therefore, slits having a light-transmitting state S are formed in portions in which the electrodes 1E, 2e, 3E, 10e, 11E, and 12e and the electrodes 1D, 2d, 3D, 10d, 11D, and 12d are superposed in plan view.

### <Effects>

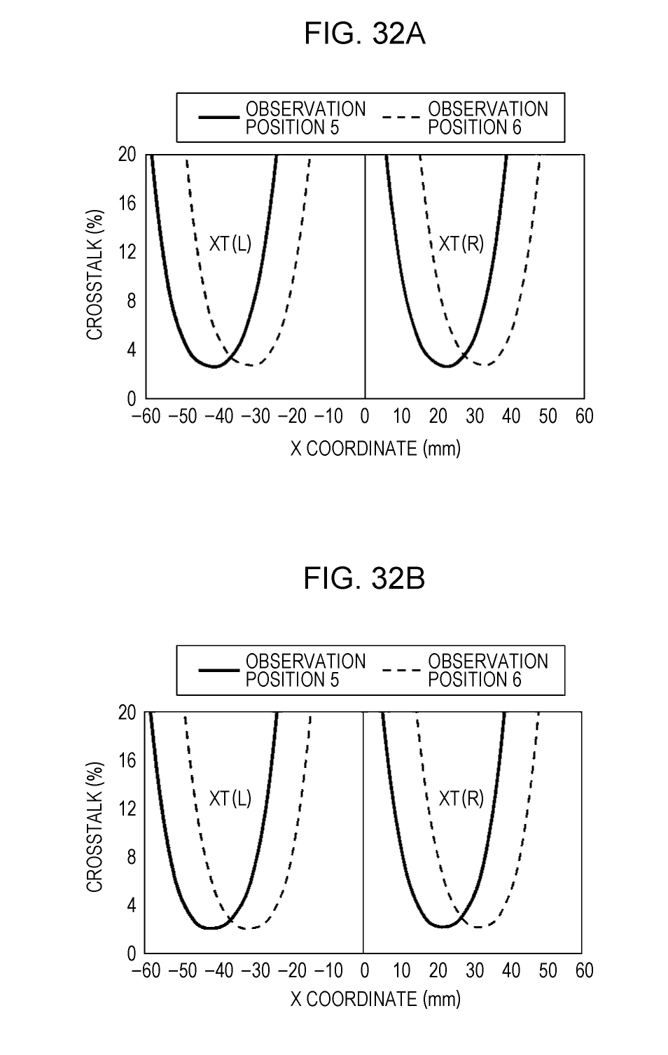

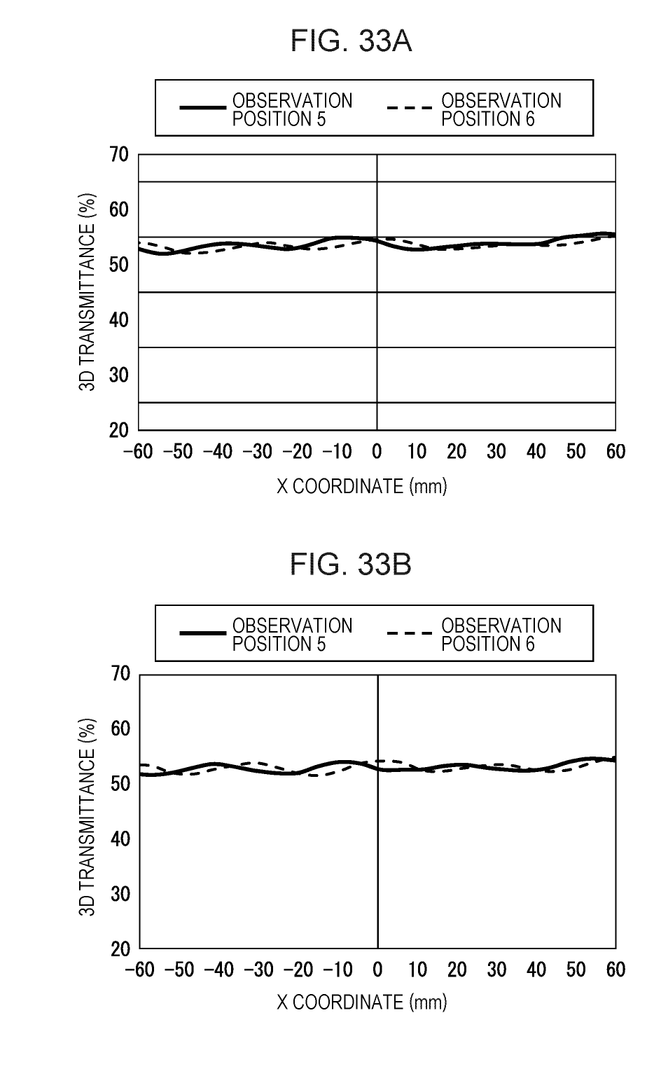

FIG. 32A is a graph depicting actual measurement results for crosstalk in observation position 5 and observation position 6 when an odd number of only barrier electrodes of the substrate 23 at the observer side have been lit up in the stereoscopic display device 1 according to the present embodiment, and FIG. 32B is a graph depicting actual measurement results for crosstalk in observation position 5 and observation position 6 when an odd number of only barrier electrodes of the substrate 21 at the main liquid crystal panel 10 side have been lit up in the stereoscopic display device 1 according to the present embodiment. Furthermore, FIG. 33A is a graph depicting actual measurement results for luminance distributions in observation position 5 and observation position 6 when an odd number of only barrier electrodes of the substrate 23 at the observer side have been lit up in the stereoscopic display device 1 according to the present embodiment, and FIG. 33B is a graph depicting actual measurement results for luminance distributions in observation position 5 and observation position 6 when an odd number of only barrier electrodes of the substrate 21 at the main liquid crystal panel 10 side have been lit up in the stereoscopic display device 1 according to the present embodiment. In either case, a rectangular alternating-current voltage of a drive frequency of 60 Hz is applied to the barrier electrodes. Furthermore, the drive voltage of the barrier electrodes is 5 V, and the number of lit-up barrier electrodes is seven in both cases. Note that, in FIGS. 32A and B and FIGS. 33A and B, the center coordinates in the X-axis direction are observation position 6. Furthermore, in FIGS. 32A and B, XT(L) indicates crosstalk for the left eye and XT(R) indicates crosstalk for the right eye.

From the results depicted in FIGS. 32A and B, it is clear that there is no difference in characteristics for crosstalk caused by a difference in observation position, between the barrier electrodes (electrodes D and d) of the substrate 23 and the barrier electrodes (electrodes E and e) of the substrate 21. Furthermore, from the results depicted in FIGS. 33A and B, it is clear that there is no difference in characteristics for luminance (3D transmittance) and there is no luminance flickering caused by a difference in observation position, between the barrier electrodes (electrodes D and d) of the substrate 23 and the barrier electrodes (electrodes E and e) of the substrate 21.

Although not depicted, also in the present embodiment and for the same reason as in embodiment 1, note that, in a case where the electrodes D are lit up, the electrode width WL2 in the X-axis direction of the electrodes D>the barrier width BL in the X-axis direction of the electrodes D. Furthermore, in a case where the electrodes e are lit up, the electrode width WU2 in the X-axis direction of the electrodes d<the barrier width BU in the X-axis direction of the electrodes d. Note that, substantially, WL2=WL1 and WU1=WU2, and the barrier width BL in the X-axis direction of the electrodes D is substantially equal to the barrier width BL in the X-axis direction of the electrodes E. Furthermore, the barrier width BU in the X-axis direction of the electrodes d is substantially equal to the barrier width BU in the X-axis direction of the electrodes D. Furthermore, in the present embodiment, the electrode width of the barrier electrodes in the X-axis direction is WU2=GL2<WL2=GU2, and therefore it is possible to implement BL=BU.

In this way, according to the present embodiment, even if the barrier pattern changes together with a change in the observation position, it is possible to maintain a satisfactory display quality without there being a difference in 3D characteristics, by means of the barrier electrodes of the substrate 23 and the barrier electrodes of the substrate 21.

Furthermore, according to the present embodiment, by providing the plurality of electrodes D and d on the substrate 23, it is possible to enlarge the region (degree of freedom) in the Z-axis direction that is stereoscopically viewable, compared to the case where the electrode 232 in the solid pattern is provided on the substrate 23 as in embodiment 1.

### Embodiment 3

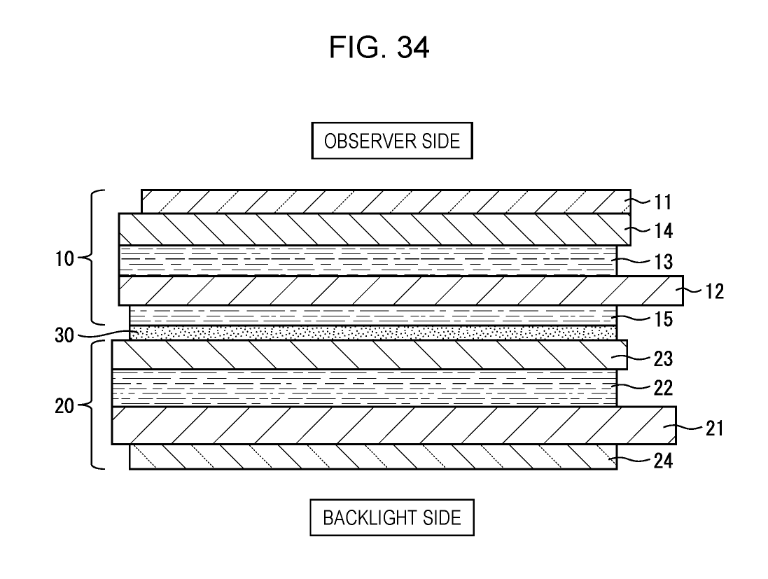

Yet another embodiment of the present disclosure is as follows when described on the basis of FIG. 34. Note that, for the convenience of the description, constituent elements having the same function as the constituent elements described in embodiments 1 and 2 are denoted by the same reference numbers and descriptions thereof are omitted.

### <Schematic Configuration of Stereoscopic Display Device 1>

The stereoscopic display device 1 according to the present embodiment is the same as the stereoscopic display devices 1 according to embodiments 1 and 2 except for the points described hereinafter.

FIG. 34 is a cross-sectional view depicting a schematic configuration of a main portion of the stereoscopic display device 1 according to the present embodiment.

As depicted in FIG. 34, the switching liquid crystal panel 20 may be arranged at the backlight 46 side of the main liquid crystal panel 10. The stereoscopic display device 1 according to the present embodiment has a configuration in which, in order from the backlight 46 side, the polarizer 24, the substrate 21, the liquid crystal layer 22, the substrate 23, the adhesive layer 30, the polarizer 15, the substrate 12, the liquid crystal layer 13, the substrate 14, and the polarizer 11 are laminated in this order from the backlight 46 side.

Note that the relationship between the absorption axis 24a of the polarizer 24 of the switching liquid crystal panel 20 and the absorption axis 15a of the polarizer 15 at the switching liquid crystal panel 20 side in the main liquid crystal panel 10 is the same as in FIG. 8. Furthermore, the main liquid crystal panel 10 according to the present embodiment is the same as the main liquid crystal panel 10 according to embodiment 2, for example. Therefore, a plan view depicting a schematic configuration of a main portion of the main liquid crystal panel 10 according to the present embodiment is the same as in FIG. 27. However, the main liquid crystal panel 10 may have the same configuration as in FIG. 4B. Furthermore, the substrate 23 in the switching liquid crystal panel 20 may have the same configuration as in FIG. 30, or may have the same configuration as in FIG. 1.

In this way, a similar effect to those of embodiments 1 and 2 can be obtained even in a case where the switching liquid crystal panel 20 is arranged at the backlight 46 side of the main liquid crystal panel 10.

### [Summary]

A stereoscopic display device 1 according to aspect 1 of the present disclosure is provided with: a display panel (main liquid crystal panel) that displays an image; and a switching liquid crystal panel 20 that is arranged superposing the display panel, in which the switching liquid crystal panel 20 is provided with a first substrate (substrate 21) and a second substrate (substrate 23) arranged in an opposing manner with a liquid crystal layer 22 interposed, the first substrate has a plurality of first electrodes (electrodes E and e) arranged in one direction (X-axis direction) of the first substrate, the second substrate has at least one second electrode (electrode 232 or electrodes D and E), the plurality of first electrodes have a plurality of first lower electrodes (electrodes E) arranged spaced apart from each other in the one direction, and a plurality of first upper electrodes (electrodes e) provided nearer to the second substrate than the first lower electrodes with a first insulating film (insulating film 237) interposed, and arranged spaced apart from each other in the one direction, gaps between the first upper electrodes that are adjacent are light-transmitting regions, the first lower electrodes are provided respectively corresponding to the gaps between the first upper electrodes in plan view in such a way that the first lower electrodes (electrodes E) and the first upper electrodes (electrodes e) are positioned in an alternating manner in the one direction in plan view, and, when an electrode width of the first lower electrodes in the one direction is taken as WL1, a gap width of gaps between the first lower electrodes in the one direction is taken as GL1, an electrode width of the first upper electrodes in the one direction is taken as WU1, and a gap width of the gaps between the first upper electrodes in the one direction is taken as GU1, WU1=GL1<WL1=GU1.

According to the aforementioned configuration, light leakage does not occur in the gaps between adjacent electrodes, and the barrier width in the one direction when the first lower electrodes are lit up and the barrier width in the one direction when the first upper electrodes are lit up can be made to be the same. Therefore, the barrier widths in the one direction produced by the plurality of first electrodes that are lit up can be made to be the same before and after a change in the observation position caused by movement of the face of an observer, and it is possible to suppress a difference in 3D characteristics caused by a change in the observation position. Therefore, according to the aforementioned configuration, it is possible to realize a stereoscopic display device with which a satisfactory display quality can be obtained even if the observation position changes.

For a stereoscopic display device 1 according to aspect 2 of the present disclosure, in the aforementioned aspect 1, WL1/WU1 may be 2 or less.

According to the aforementioned configuration, the barrier widths produced when barriers are lit up can be made to be the same, and therefore a satisfactory display quality can be obtained even if the observation position changes.

For a stereoscopic display device 1 according to aspect 3 of the present disclosure, in the aforementioned aspect 1 or 2, a width (barrier width BU) in the one direction of a region (barrier) in which light from the display panel is shielded by one of the first upper electrodes when the first upper electrodes are lit up, and a width (barrier width BL) in the one direction of a region (barrier) in which light from the display panel is shielded by one of the first lower electrodes when the first lower electrodes are lit up may be equal.

According to the aforementioned configuration, as mentioned above, the barrier widths in the one direction produced by the plurality of first electrodes that are lit up can be made to be the same before and after a change in the observation position caused by movement of the face of the observer, and it is possible to suppress a difference in 3D characteristics caused by a change in the observation position. Therefore, according to the aforementioned configuration, it is possible to realize a stereoscopic display device with which a satisfactory display quality can be obtained even if the observation position changes.

For a stereoscopic display device 1 according to aspect 4 of the present disclosure, in any of the aforementioned aspects 1 to 3, the second electrode may be a common electrode in the solid pattern (electrode 232), which is arranged in an opposing manner common to the plurality of first electrodes.

According to the aforementioned configuration, by means of the first electrodes, it is possible to switch between a region (barrier) in which light from the display panel is shielded and a region (slit) in which light from the display panel is transmitted. Furthermore, the configuration of the second substrate can be simplified compared to a case where a plurality of second electrodes are provided on the second substrate.

For a stereoscopic display device 1 according to aspect 5 of the present disclosure, in any of the aforementioned aspects 1 to 3, the second electrode may be arranged in plurality in the one direction on the second substrate, the plurality of second electrodes may have a plurality of second lower electrodes (electrodes D) arranged spaced apart from each other in the one direction, and a plurality of second upper electrodes (electrodes d) provided nearer to the first substrate than the second lower electrodes with a second insulating film (insulating film 215) interposed, and arranged spaced apart from each other in the one direction, gaps between the second upper electrodes that are adjacent may be light-transmitting regions, the second lower electrodes may be provided respectively corresponding to the gaps between the second upper electrodes in plan view in such a way that the second lower electrodes (electrodes D) and the second upper electrodes (electrodes d) are positioned in an alternating manner in the one direction in plan view, and, when an electrode width of the second lower electrodes in the one direction is taken as WL2, a gap width of gaps between the second lower electrodes in the one direction is taken as GL2, an electrode width of the second upper electrodes in the one direction is taken as WU2, and a gap width of the gaps between the second upper electrodes in the one direction is taken as GU2, WU2=GL2 may be less than WL2=GU2.

According to the aforementioned configuration, as mentioned above, the barrier widths in the one direction produced by the plurality of first electrodes that are lit up can be made to be the same before and after a change in the observation position caused by movement of the face of the observer, and it is possible to suppress a difference in 3D characteristics caused by a change in the observation position. Therefore, according to the aforementioned configuration, it is possible to realize a stereoscopic display device with which a satisfactory display quality can be obtained even if the observation position changes.

Furthermore, by providing the plurality of second electrodes on the second substrate, it is possible to enlarge the region (degree of freedom) in the Z-axis direction that is stereoscopically viewable, compared to the case where a second electrode in the solid pattern is provided on the second substrate.

For a stereoscopic display device 1 according to aspect 6 of the present disclosure, in the aforementioned aspect 5, WL2/WU2 may be 2 or less.

According to the aforementioned configuration, the barrier widths produced when barriers are lit up can be made to be the same, and therefore a satisfactory display quality can be obtained even if the observation position changes.

For a stereoscopic display device 1 according to aspect 7 of the present disclosure, in the aforementioned aspect 5 or 6, the first lower electrodes and the second lower electrodes may be arranged in a superposed manner, and the first upper electrodes and the second upper electrodes may be arranged in a superposed manner.

According to the aforementioned configuration, it is possible to easily switch between barriers and slits by supplying signals of phases that have opposite polarities, to some electrodes of either one of the plurality of first electrodes and the plurality of second electrodes (for example, some electrodes from among the plurality of first upper electrodes and some electrodes from among the plurality of first lower electrodes), and to the other remaining electrodes.

For a stereoscopic display device 1 according to aspect 8 of the present disclosure, in any of the aforementioned aspects 5 to 7, a width (barrier width BU) in the one direction of a region (barrier) in which light from the display panel is shielded by one of the second upper electrodes when the second upper electrodes are lit up, and a width (barrier width BL) in the one direction of a region (barrier) in which light from the display panel is shielded by one of the second lower electrodes when the second lower electrodes are lit up may be equal.

According to the aforementioned configuration, as mentioned above, the barrier widths in the one direction produced by the plurality of second electrodes that are lit up can be made to be the same before and after a change in the observation position caused by movement of the face of the observer, and it is possible to suppress a difference in 3D characteristics caused by a change in the observation position. Therefore, according to the aforementioned configuration, it is possible to realize a stereoscopic display device with which a satisfactory display quality can be obtained even if the observation position changes.

For a stereoscopic display device 1 according to aspect 9 of the present disclosure, in any of the aforementioned aspects 1 to 8, the switching liquid crystal panel may be arranged nearer to an observer than the display panel.

For a stereoscopic display device 1 according to aspect 10 of the present disclosure, in any of the aforementioned aspects 1 to 8, the display panel may be arranged nearer to an observer than the switching liquid crystal panel.

The present disclosure is not restricted to the aforementioned embodiments, various alterations are possible within the scope indicated in the claims, and embodiments obtained by appropriately combining the technical means disclosed in each of the different embodiments are also included within the technical scope of the present disclosure. In addition, novel technical features can be formed by combining the technical means disclosed in each of the embodiments.

The present disclosure contains subject matter related to that disclosed in Japanese Priority Patent Application JP 2017-238653 filed in the Japan Patent Office on Dec. 13, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A stereoscopic display device comprising:
a display panel that displays an image; and
a switching liquid crystal panel that is arranged superposing the display panel,
wherein the switching liquid crystal panel is provided with a first substrate and a second substrate arranged in an opposing manner with a liquid crystal layer interposed,
the first substrate has a plurality of first electrodes arranged in one direction of the first substrate,
the second substrate has at least one second electrode,
the plurality of first electrodes have a plurality of first lower electrodes arranged spaced apart from each other in the one direction, and a plurality of first upper electrodes provided nearer to the second substrate than the first lower electrodes with a first insulating film interposed, and arranged spaced apart from each other in the one direction,
gaps between the first upper electrodes that are adjacent are light-transmitting regions,
the first lower electrodes are provided respectively corresponding to the gaps between the first upper electrodes in plan view in such a way that the first lower electrodes and the first upper electrodes are positioned in an alternating manner in the one direction in plan view, and,
when an electrode width of the first lower electrodes in the one direction is taken as WL1, a gap width of gaps between the first lower electrodes in the one direction is taken as GL1, an electrode width of the first upper electrodes in the one direction is taken as WU1, and a gap width of the gaps between the first upper electrodes in the one direction is taken as GU1, WU1=GL1<WL1=GU1.

2. The stereoscopic display device according to claim 1,
wherein WL1/WU1≤2.

3. The stereoscopic display device according to claim 1,
wherein a width in the one direction of a region in which light from the display panel is shielded by one of the first upper electrodes when the first upper electrodes are lit up, and a width in the one direction of a region in which light from the display panel is shielded by one of the first lower electrodes when the first lower electrodes are lit up are equal.

4. The stereoscopic display device according to claim 1,
wherein the second electrode is a common electrode in the solid pattern, which is arranged in an opposing manner common to the plurality of first electrodes.

5. The stereoscopic display device according to claim 1,
wherein the second electrode is arranged in plurality in the one direction on the second substrate,
the plurality of second electrodes have a plurality of second lower electrodes arranged spaced apart from each other in the one direction, and a plurality of second upper electrodes provided nearer to the first substrate than the second lower electrodes with a second insulating film interposed, and arranged spaced apart from each other in the one direction,
gaps between the second upper electrodes that are adjacent are light-transmitting regions,
the second lower electrodes are provided respectively corresponding to the gaps between the second upper electrodes in plan view in such a way that the second lower electrodes and the second upper electrodes are positioned in an alternating manner in the one direction in plan view, and,
when an electrode width of the second lower electrodes in the one direction is taken as WL2, a gap width of gaps between the second lower electrodes in the one direction is taken as GL2, an electrode width of the second upper electrodes in the one direction is taken as WU2, and a gap width of the gaps between the second upper electrodes in the one direction is taken as GU2, WU2=GL2<WL2=GU2.

6. The stereoscopic display device according to claim 5,
wherein WL2/WU2≤2.

7. The stereoscopic display device according to claim 5,
wherein the first lower electrodes and the second lower electrodes are arranged in a superposed manner, and the first upper electrodes and the second upper electrodes are arranged in a superposed manner.

8. The stereoscopic display device according to claim 5,
wherein a width in the one direction of a region in which light from the display panel is shielded by one of the second upper electrodes when the second upper electrodes are lit up, and a width in the one direction of a region in which light from the display panel is shielded by one of the second lower electrodes when the second lower electrodes are lit up are equal.

9. The stereoscopic display device according to claim 1,
wherein the switching liquid crystal panel is arranged nearer to an observer than the display panel.

10. The stereoscopic display device according to claim 1,
wherein the display panel is arranged nearer to an observer than the switching liquid crystal panel.
